(19) United States
(12) Patent Application Publication
(10) Pub. No.: US 2020/0008095 A1
(43) Pub. Date: Jan. 2, 2020

(54) CONNECTIVITY AND FEEDBACK TECHNIQUES FOR WIRELESS BROADCAST SERVICES

(71) Applicant: QUALCOMM Incorporated, San Diego, CA (US)

(72) Inventors: Abhishek Pramod Patil, San Diego, CA (US); George Cherian, San Diego, CA (US); Jouni Kalevi Malinen, Tuusula (FI); Alfred Asterjadhi, San Diego, CA (US)

(21) Appl. No.: 16/453,954

(22) Filed: Jun. 26, 2019

Related U.S. Application Data
(60) Provisional application No. 62/692,635, filed on Jun. 29, 2018.
(60) Provisional application No. 62/692,644, filed on Jun. 29, 2018.

(51) Int. Cl. H04W 28/04; H04W 4/06; H04W 48/10; H04W 52/02; H04W 76/15; H04W 76/28; H04L 1/16; H04L 9/30; H04L 9/32; H04W 12/04; H04W 12/00

(52) U.S. Cl. CPC H04W 28/04; H04W 4/06; H04W 48/10; H04W 52/0216; H04W 52/0222; H04W 76/15; H04W 84/12; H04L 1/1685; H04L 9/30; H04L 9/3242; H04W 12/04031; H04W 12/001; H04W 76/28

(57) ABSTRACT

This disclosure provide systems, devices, apparatus and methods, including computer programs encoded on storage media, for broadcast services feedback techniques. Several broadcast connectivity and feedback techniques are described. A broadcast connectivity protocol may be used by different types of wireless communication devices (such as an access point (AP) and station (STA)) to provide or access broadcast services. A security protocol or enhancement to the broadcast connectivity protocol may provide source authentication or verification for broadcast transmissions. The broadcast services feedback techniques can enable an AP to obtain feedback from one or more STAs. In some implementations, a negative acknowledgement (NACK) scheme may be used to efficiently obtain feedback from multiple STAs. The broadcast connectivity and feedback techniques may be used by a STA that does not have a wireless association with the AP. The techniques may be useful in servicing a multiple STAs in an environment.

### CROSS-REFERENCE TO RELATED APPLICATIONS

This Patent Application claims priority to U.S. Provisional Patent Application No. 62/692,644 filed Jun. 29, 2018 and entitled “CONNECTIVITY TECHNIQUES FOR WIRELESS BROADCAST SERVICES,” and U.S. Provisional Patent Application No. 62/692,635 filed Jun. 29, 2018 and entitled “FEEDBACK TECHNIQUES FOR WIRELESS BROADCAST SERVICES,” both assigned to the assignee hereof. The disclosures of the prior Applications are considered part of, and are incorporated by reference in, this Patent Application.

### TECHNICAL FIELD

This disclosure relates generally to wireless communication, and more specifically, to broadcast services in a wireless network.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A STA may have a wireless connection (referred to as a wireless association, or just “association”) when it has authenticated and established a wireless session with the AP. Recently, the IEEE is considering new uses for a WLAN which may benefit from a different type of relationship between an AP and a STA. For example, it may be desirable for an AP to support broadcast services via a WLAN. In some scenarios, the broadcast services from an AP may be consumed by a recipient STA that has not established a wireless session (association) with the AP. In some such scenarios, while in an unassociated state, a STA may send or receive wireless communication with the AP without having an authenticated wireless session. Applications for broadcast services may include the broadcast of “local information” at events, shopping malls, tourist attractions, train stations, airports, etc. Broadcast services also may be used for the broadcast of dynamic information, such as emergency alerts, vehicular traffic updates, parking availability, emergency information, among other examples.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method includes determining that a first access point (AP) of a wireless local area network (WLAN) provides a broadcast service (eBCS), receiving one or more wireless broadcast frames of the broadcast service from the first AP using a broadcast connectivity protocol, wherein the broadcast connectivity protocol includes a broadcast services feedback technique, and transmitting, from the first STA to the first AP, feedback regarding reception of the one or more wireless broadcast frames in accordance with the broadcast services feedback technique.

Another innovative aspect of the subject matter described in this disclosure can be implemented in a wireless communication device. The wireless communication device includes at least one processor and at least one memory communicatively coupled with the at least one processor and storing processor-readable code that, when executed by the at least one processor, causes the wireless communication device to perform operations. The operations include determining that a first access point (AP) of a wireless local area network (WLAN) provides a broadcast service (eBCS), receiving one or more wireless broadcast frames of the broadcast service from the first AP using a broadcast connectivity protocol, wherein the broadcast connectivity protocol includes a broadcast services feedback technique, and transmitting, from the first STA to the first AP, feedback regarding reception of the one or more wireless broadcast frames in accordance with the broadcast services feedback technique.

In some implementations, determining that the first AP provides the broadcast service may include receiving an advertisement message that indicates the broadcast service, wherein the advertisement message indicates one or more broadcast services available from the first AP.

In some implementations, the broadcast connectivity protocol may include an outside context of a basic service set (OCB) protocol, and wherein determining that the first AP provides the broadcast service includes receiving one or more OCB wireless broadcast frames.

In some implementations, the methods and wireless communication devices may be configured to determine wake-up periods associated with the broadcast service based on a schedule for the one or more OCB wireless broadcast frames, and receive the one or more wireless broadcast frames using the broadcast connectivity protocol for the broadcast service during the wake-up periods.

In some implementations, determining the wake-up periods may include receiving a broadcast target wake time (TWT) schedule or a burst schedule from the first AP via the OCB protocol.

In some implementations, the methods and wireless communication devices may be configured to determine that the first AP supports a pre-association process or a fast-association process for the broadcast service.

In some implementations, the methods and wireless communication devices may be configured to maintain a communication link with a second AP for non-broadcast traffic, periodically access the broadcast service provided by the first AP during some time periods, and communicate with the second AP during other time periods between periodically accessing the broadcast service.

In some implementations, the broadcast connectivity protocol for the broadcast service does not include establishing a wireless association with the first AP.

In some implementations, the methods and wireless communication devices may be configured to obtain a public key associated with the first AP prior to receiving the one or more wireless broadcast frames, and decrypt at least a portion of the one or more wireless broadcast frames using the public key, wherein the public key is usable to verify that the one or more wireless broadcast frames originated from the first AP having a corresponding private key.

In some implementations, the one or more wireless broadcast frames include a message authentication code (MAC). In some implementations, the methods and wireless communication devices may be configured to verify the MAC using a key included in a subsequent wireless broadcast frame from the first AP.

In some implementations, the methods and wireless communication devices may be configured to receive, from the first AP, a request for the feedback regarding reception of the one or more wireless broadcast frames, and determine whether to transmit the feedback based, at least in part, on the broadcast services feedback technique implemented by the first AP.

In some implementations, the broadcast services feedback technique includes a negative acknowledgement (NACK) message scheme and the feedback includes a NACK message.

In some implementations, the request includes a request that the first STA respond with feedback if the first STA determines that it has not received a threshold quantity of wireless broadcast frames during a broadcast period.

In some implementations, the broadcast services feedback technique includes a negative acknowledgement (NACK) voting scheme and the feedback includes a short feedback transmission.

In some implementations, the methods and wireless communication devices may be configured to determine one or more NACK time periods relative to a start time for the short feedback transmission, the one or more NACK time periods corresponding to missing broadcast segments not received by the first STA. In some implementations, the methods and wireless communication devices may be configured to transmit radio frequency energy during the one or more NACK time periods.

In some implementations, sending the feedback includes transmitting the short feedback transmission concurrently with a transmission from a second STA such that the short feedback transmission includes at least one bit value that is reinforced by radio energy contributed by both the first STA and the second STA.

In some implementations, the methods and wireless communication devices may be configured to establish an affiliation status with the first AP without establishing a wireless association with the first AP.

In some implementations, the methods and wireless communication devices may be configured to receive other wireless broadcast frames from a second AP, and combine data from the other wireless broadcast frames with data from the one or more wireless broadcast frames to recover a broadcast transmission.

Another innovative aspect of the subject matter described in this disclosure can be implemented in a method for wireless communication. The method includes providing a broadcast service (eBCS) via a wireless local area network (WLAN), determining that at least a first station (STA) is attentive to the broadcast service, transmitting one or more wireless broadcast frames of the broadcast service using a broadcast connectivity protocol, wherein the broadcast connectivity protocol includes a broadcast services feedback technique, and receiving feedback from the first STA regarding reception of the one or more wireless broadcast frames in accordance with the broadcast services feedback technique.

Another innovative aspect of the subject matter described in this disclosure can be implemented in a wireless communication device. The wireless communication device includes at least one processor and at least one memory communicatively coupled with the at least one processor and storing processor-readable code that, when executed by the at least one processor, causes the wireless communication device to perform operations. The operations include providing a broadcast service (eBCS) via a wireless local area network (WLAN), determining that at least a first station (STA) is attentive to the broadcast service, transmitting one or more wireless broadcast frames of the broadcast service using a broadcast connectivity protocol, wherein the broadcast connectivity protocol includes a broadcast services feedback technique, and receiving feedback from the first STA regarding reception of the one or more wireless broadcast frames in accordance with the broadcast services feedback technique.

In some implementations, the methods and wireless communication devices may be configured to transmit an advertisement message regarding the broadcast service provided by the first AP.

In some implementations, the methods and wireless communication devices may be configured to transmit a schedule or target wake time (TWT) information useable by the first STA to determine wake-up periods associated with the broadcast service.

In some implementations, the methods and wireless communication devices may be configured to provide a first basic service set (BSS) that is different from the broadcast service, wherein the first BSS provides a wireless communication link for unicast traffic between the first AP and the first STA.

In some implementations, the methods and wireless communication devices may be configured to encrypt at least a portion of the one or more wireless broadcast frames using a private key that has a corresponding public key, and provide the corresponding public key to the first STA prior to transmitting the one or more wireless broadcast frames.

In some implementations, the methods and wireless communication devices may be configured to generate a temporary key, generate a message authentication code (MAC) based, at least in part, on the temporary key, transmit the MAC with a first one of the one or more wireless broadcast frames, and transmit the temporary key in a second one of the one or more wireless broadcast frames.

In some implementations, the methods and wireless communication devices may be configured to transmit, from the first AP, a request for feedback regarding reception of the one or more wireless broadcast frames by a STA, and receive the feedback from the first STA in response to the request.

In some implementations, the methods and wireless communication devices may be configured to determine a modulation coding scheme (MCS) for subsequent wireless broadcast frames based, at least in part, on the feedback.

In some implementations, the methods and wireless communication devices may be configured to select a different MCS with a higher data rate for the subsequent wireless broadcast frames when the feedback indicates that a threshold percentage of STAs successfully received the one or more wireless broadcast frames.

In some implementations, the broadcast services feedback technique includes one of: a NACK message scheme available to associated and unassociated STAs, a NACK voting scheme available to associated and unassociated STAs, and a BA message scheme available to only associated STAs.

In some implementations, the feedback is a short feedback transmission. In some implementations, the methods and wireless communication devices may be configured to determine one or more NACK time periods relative to a start time for the short feedback transmission, wherein each of the one or more NACK time periods correspond to different broadcast segments, detect an amount of radio frequency energy during each the one or more NACK time periods, and determine, based on which of the one or more NACK time periods have radio frequency energy above a threshold amount, which broadcast segments to retransmit.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communication network.

FIG. 2 shows a pictorial diagram of an example wireless communication network that implements broadcast services.

FIG. 3A shows an example protocol data unit (PDU) usable for communications between an access point (AP) and a number of stations (STAs).

FIG. 3B shows an example field in the PDU of FIG. 3A.

FIG. 4A shows a pictorial diagram of an example wireless communication network using a neighbor awareness networking (NAN) protocol for broadcast services.

FIG. 4B shows a pictorial diagram in which a NAN network may include different NAN Data Links (NDLs) to support different applications or services.

FIG. 4C shows a pictorial diagram of an example wireless communication network using an independent Basic Service Set (IBSS) for broadcast services.

FIG. 4D shows a pictorial diagram of an example wireless communication network using an “outside the context of a basic service set” (OCB) protocol for broadcast services.

FIG. 5A shows a pictorial diagram of an example use case of broadcast services for emergency alert data.

FIG. 5B shows a pictorial diagram of an example use case of broadcast services for vehicular use data.

FIG. 6 shows a message flow diagram illustrating example broadcast connectivity techniques.

FIG. 7A shows a message flow diagram illustrating example broadcast services feedback techniques using wireless association.

FIG. 7B shows a message flow diagram illustrating example broadcast services feedback techniques in an unassociated state.

FIG. 8 shows an example of redundant broadcast and negative acknowledgement (NACK) feedback.

FIG. 9 shows a pictorial diagram of example scenarios with multiple APs.

FIG. 10A shows a pictorial diagram of an example security protocol.

FIG. 10B shows a pictorial diagram of another example security protocol.

FIG. 11 shows a block diagram of an example wireless communication device.

FIG. 12A shows a block diagram of an example access point (AP).

FIG. 12B shows a block diagram of an example station (STA).

FIG. 13 shows a flowchart illustrating an example process for establishing connectivity for broadcast services.

FIG. 14 shows a flowchart illustrating an example process for providing feedback for broadcast services.

FIG. 15 shows a flowchart illustrating another example process for establishing connectivity for broadcast services.

FIG. 16 shows a flowchart illustrating an example process for processing feedback for broadcast services.

FIG. 17 shows a block diagram of an example wireless communication device for use in wireless communication.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

The development of new uses and applications for wireless communication have precipitated a desire for broadcast transmissions in a wireless network. The IEEE has recently begun working on a draft standard specification (referred to as IEEE 802.11bc) for enhanced broadcast services (eBCS) that may support broadcast services. For example, broadcast transmissions can be communicated from an access point (AP) concurrently to multiple wireless stations (STAs). Examples of broadcast transmissions may include information regarding venues, events, broadcast video content, shopping malls, tourist attractions, train stations, airports, emergency alerts, vehicular traffic updates, parking availability, emergency information, information from IoT devices, among other examples. In some scenarios, the broadcast transmissions may include an unsolicited downlink broadcast from an AP to a large number of STAs. The STAs may be wirelessly associated with the AP or may not be associated with the AP. In some scenarios, the STAs may execute a broadcast services application that is configured to receive the broadcast transmissions without establishing a wireless session with the AP.

Previous techniques for establishing a wireless connection (wireless association) between a STA and an AP may be ineffective, slow, or otherwise undesirable for some broadcast applications. For example, a STA and AP may benefit from communicating broadcast information without establishing a full wireless association. Alternatively, a pre-association, light-association, or fast-association may improve the establishment of a broadcast wireless connection. While some communication protocols are available for one-to-one, one-to-many, or peer-to-peer communications, the existing protocols used for WLAN communication may not be effective for broadcast services. Furthermore, previous solutions for broadcast wireless transmissions may be inefficient or may consume more of the wireless communication medium resources than is necessary. For example, an AP may select a data rate for the broadcast transmissions that consumes a large amount of the wireless resources (in terms of time or frequency utilization). Additionally, unless the AP receives feedback, the AP may use a fixed low data rate, which may result in performance degradation for other users on the wireless channel. Furthermore, redundancy and retransmission schemes may provide more reliability, but at the cost of resource utilization. The consumption of wireless resources for broadcast transmissions also may limit the wireless resources left for unicast transmissions.

Traditional techniques for connectivity and feedback may be unsuitable for broadcast services, especially when a large number of STAs are consuming the broadcast transmissions. For example, previously existing techniques for feedback are not scalable and may require a wireless association that is otherwise not needed for broadcast services. If an AP has relevant information (such as feedback from STAs) regarding how well the broadcast transmissions are being received by the STAs, the AP may optimize a data rate, retransmission, or redundancy scheme.

In this disclosure, various broadcast connectivity protocols are described. Some implementations relate to connectivity protocols for use with STAs that do not have a wireless association (which may be referred to as an “unassociated state”) with the AP. In some implementations, an AP may advertise the broadcast services using the broadcast connectivity protocol. The STA may subscribe to the broadcast services or otherwise indicate that the STA is attentive to the broadcast services. In some implementations, the broadcast connectivity protocol may be used to establish an affiliate or subscription relationship between the AP and the STA. In some implementations, the AP may not operate a Basic Service Set (BSS) or may transmit broadcast frames without requiring a BSS association.

Different protocols may be adapted or modified to support broadcast services. For example, in some implementations, the broadcast connectivity protocol may include a neighbor awareness network (NAN) protocol, an “outside the context of a BSS” (OCB) protocol, among other examples. In some other implementations, the broadcast technology protocol may utilize an infrastructure BSS or an independent BSS. This description provides examples of how different protocols may be used or modified to support broadcast services. For example, the protocols may be modified to support broadcast connectivity between an AP and a STA or between two peer wireless communication devices such as two peer STAs in proximity to one another.

In some implementations, the broadcast connectivity protocols may enable power saving by providing scheduling or other deterministic wake-up times associated with the broadcast connectivity protocol. For example, an AP or a STA may determine target wake times (TWTs) based on the broadcast connectivity protocol. A STA may enter a power save mode during other time periods and still wake-up to receive the broadcast transmissions during the deterministic wake-up times. Alternatively, or additionally, the STA may access another AP (or another BSS) during the other time periods.

In some implementations, the broadcast connectivity protocol may be enhanced with security features. For example, the use of authentication, a handshake, or cryptography may be used to provide security for the broadcast transmissions. Absent the security enhancements, it may be possible for a rogue STA to spoof or mimic an AP by utilizing a common group key. In some implementations, the security enhancements may address this concern by using public key cryptography or asymmetric encryption that verifies the source of the broadcast transmissions. In some implementations, the use of a security protocol (such as the Timed Efficient Stream Loss-tolerant Authentication, or TESLA, protocol) may provide source verification for broadcast transmissions.

This disclosure also provides various broadcast services feedback techniques in which feedback can be obtained from a large number of recipient STAs in an efficient and scalable manner. As described above, some implementations relate to broadcast services feedback techniques for use with STAs that have wireless associations with an AP, while other implementations relate to broadcast services feedback techniques for use with STAs that do not have a wireless association (which may be referred to as an “unassociated state”) with the AP.

In some implementations, the broadcast services feedback techniques may use a negative acknowledgment (NACK) scheme that can reduce the overhead associated with gathering feedback from multiple STAs. In some implementations, the broadcast transmissions may include a plurality of redundant or retransmitted broadcast segments, or may include forward error correction (FEC) encoded broadcast segments. The NACK scheme may involve NACK messages from STAs that do not receive a sufficient quantity of broadcast segments to recover the broadcast information. In some implementations, the NACK scheme may enable concurrent feedback from multiple STAs using a voting or polling type short feedback message. In some implementations, feedback may be obtained from a representative subset of a plurality of STAs, such that the feedback may represent the success of the broadcast transmissions without soliciting feedback from all of the STAs consuming the broadcast transmissions.

Particular implementations of the subject matter described in this disclosure can be implemented to realize one or more of the following potential advantages. Broadcast services can be deployed to support a new range of applications. Connectivity between a broadcaster (such as an AP) and a recipient (such as a STA) can be established using one or more of the described broadcast connectivity protocols. In some implementations, the described techniques can be used to optimize resource utilization by a wireless network that supports broadcast services. For example, an AP may optimize the data rate, modulation and coding scheme (MC S), redundancy configuration, FEC configuration, among other examples, based on feedback from STAs. As a result of optimizing the broadcast transmissions, the AP may reduce the quantity of retransmissions or may reduce the resource utilization associated with broadcast transmissions.

For brevity, in this disclosure several examples are described in terms of a STA and an AP. However, the broadcast services described in this disclosure can be used by different types of devices, such as STAs, APs, or any combination of STAs and APs. For example, the AP described in this disclosure may be a STA performing the features of the described AP that is providing broadcast services for other STAs in a peer-to-peer, mesh, or other ad hoc logical hierarchical arrangement.

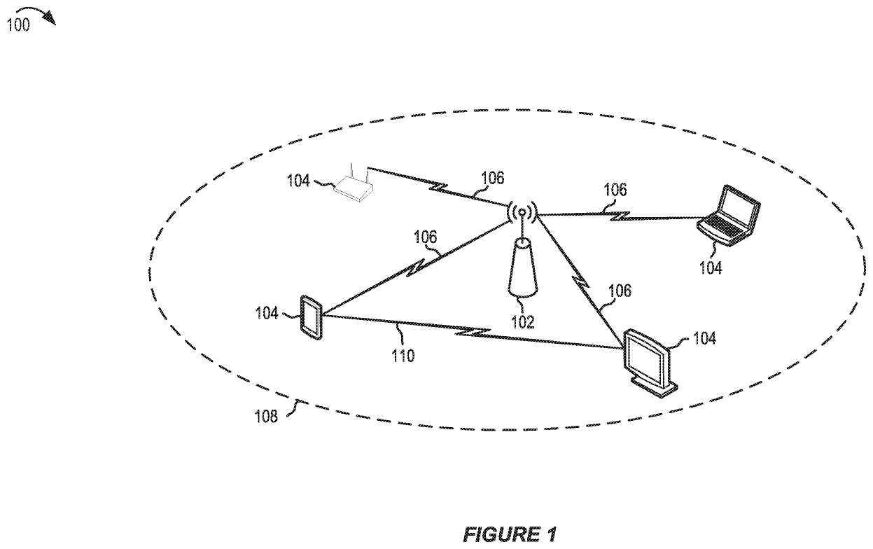

FIG. 1 shows a pictorial diagram of an example wireless communication network. FIG. 1 includes a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11aa, 802.11ah, 802.11ad, 802.11aq, 802.11ay, 802.11ax, 802.11az, 802.11ba and 802.11be). The WLAN 100 may include numerous wireless communication devices such as an access point (AP) 102 and multiple stations (STAs) 104 that have a wireless association with the AP 102. In addition, there may be STAs (not shown) that do not have a wireless association with the AP 102. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a media access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

FIG. 1 additionally shows an example coverage area 108 of the AP 102, which may represent a basic service area (BSA) of the WLAN 100. As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of standards (such as that defined by the IEEE 802.11-2016 specification or amendments thereof including, but not limited to, 802.11aa, 802.11ah, 802.11aq, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PLCP service data unit (PSDU). For example, the PSDU may include a PLCP preamble and header as well as one or more MAC protocol data units (MPDU5). The information provided in the PHY preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

The communication link 106 may carry downlink broadcast transmissions to the associated STAs 104. In some implementations, unassociated STAs (not shown) also may be capable of receiving broadcast services from the AP 102 using broadcast connectivity techniques described in this disclosure.

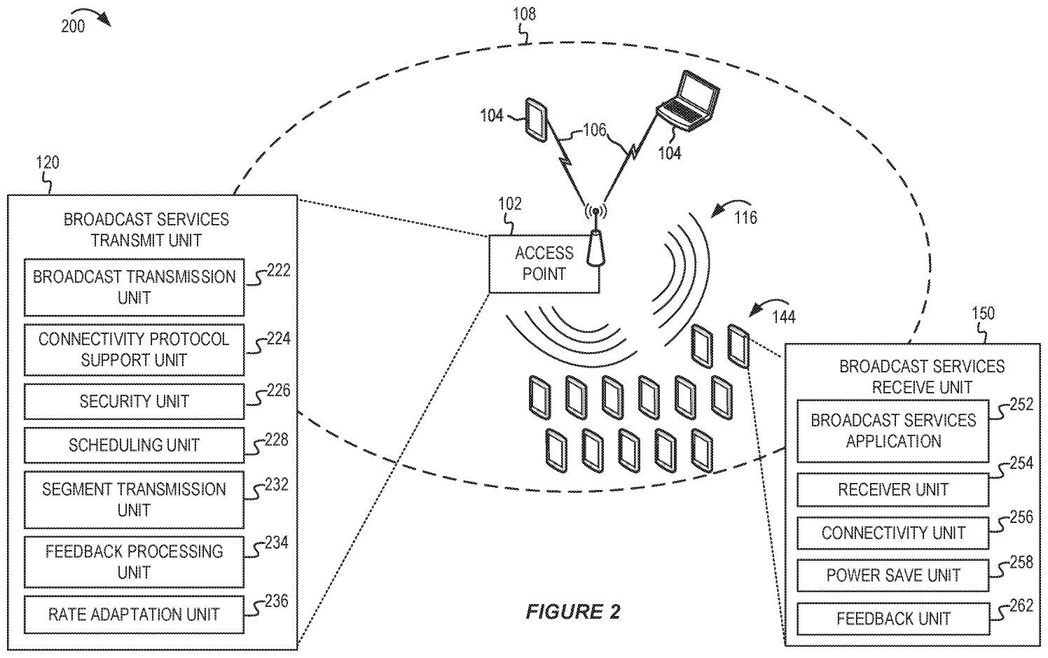

FIG. 2 shows a pictorial diagram of an example wireless communication network 200 that implements broadcast services. FIG. 2 shows downlink broadcast transmissions via broadcast signals 116 which can be transmitted by the AP 102 in the coverage area 108. In addition to the STAs 104, the broadcast signals 116 may be received by multiple STAs 144, even though the STAs 144 may not have a wireless association with the AP 102. As described above, the AP 102, STAs 104, and STAs 144 may benefit from using a broadcast connectivity protocol to establish the broadcast services. While described in terms of downlink broadcast transmissions for brevity, the techniques in this disclosure also may be used for uplink broadcast transmissions.

The AP 102 may include a broadcast services transmit unit 120 to manage the transmission of broadcast transmissions. The broadcast services transmit unit 120 in FIG. 2 includes several features which may be implemented in various combinations. The broadcast services transmit unit 120 may include a broadcast transmission unit 222. For example, the broadcast transmission unit 222 may cause source broadcast information to be transmitted via one or more broadcast frames. The broadcast transmission unit 222 may send one or more broadcasts to indicate that the AP 102 supports broadcast services using a broadcast connectivity protocol. For example, the broadcast transmission unit 222 may transmit a generic advertisement services (GAS) message to advertise what broadcast services are available.

In some implementations, the broadcast transmission unit 222 may transmit a message that includes a hash or hint payload that indicates the available broadcast services. For example, a hash payload may include hashed indicators for one or more broadcast services. A STA 144 may search the hash payload for a particular hash indicator associated with a desired broadcast service. Alternatively, a hint payload is similar to the hashed indicators except that the hint may include a portion of the hashed indicators to reduce the overhead associated with the payload of the service advertisement. For example, the hint payload may be a bloom filter representation of the services that are supported by the AP 102. The hashed or hint indicators may be sent by the AP 102 to indicate that the AP 102 has access to particular services. The STA 144 may utilize the AP 102 for a specific service identified in the hashed or hint indicators. Related to broadcast connectivity, an AP 102 may broadcast one or more services which can be identified by the hashed or hint indicators. The STA 144 may determine to stay on a channel to listen for a broadcast frame from the AP 102 if the AP 102 has indicated (such as in a beacon frame or GAS frame) that the AP 102 supports a certain broadcast service. Alternatively, or additionally, a broadcast frame from the AP 102 may carry information (such as hint or hash) to let the client know which service is included in that broadcast frame. The STA 144 may determine whether to further process the remainder of the broadcast frame or discard the broadcast frame depending on whether the STA 144 is interested in the particular service.

In some implementations, the STA 144 may receive and process broadcast frames from the AP 102 without establishing a fully authenticated wireless association. For example, the STA 144 may have no association, a pre-association, a light-association, or a fast-association session with the AP 102. For example, the AP 102 may provide a group address key which can be used by any STAs (including the STAs 144) to process the broadcast frames. The broadcast frames are not individually addressed data to a specific client, but may be addressed to a broadcast, null, reserved, or group address. In some implementations, the AP 102 may not assign an association identifier (AID) to each STA 144. In some implementations, the broadcast transmission unit 222 may transmit the source broadcast information as a series of segments. The broadcast transmission unit 222 may cause the segments to be transmitted via one or more wireless broadcast frames (for example, as carried by PPDUs).

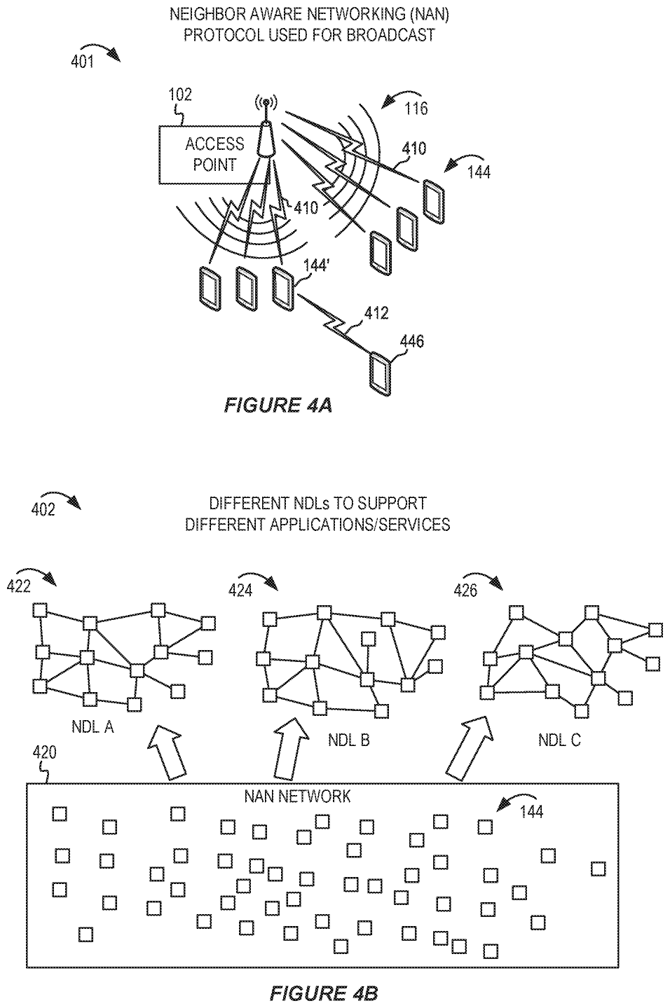

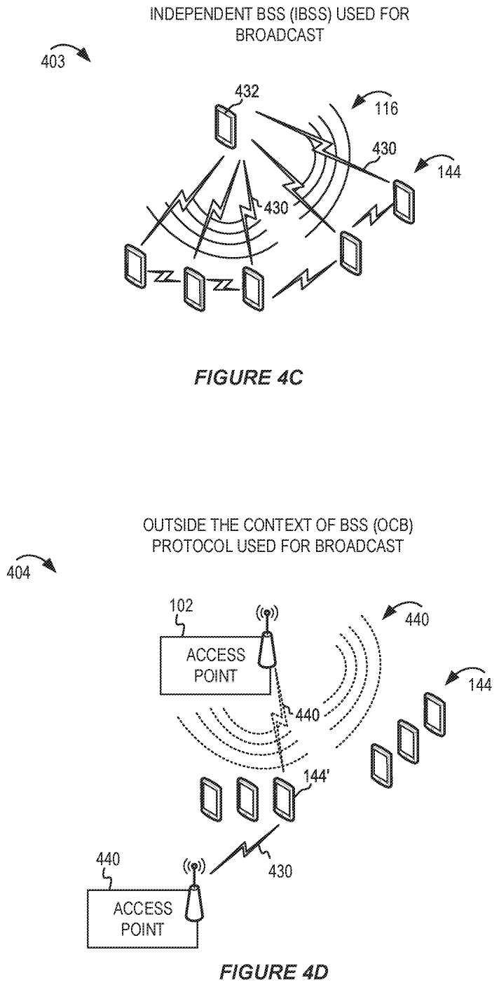

The broadcast services transmit unit 120 also may include a connectivity protocol support unit 224. The connectivity protocol support unit 224 may implement a broadcast connectivity protocol using modifications to a traditional connectivity protocol. For example, the connectivity protocol support unit 224 may implement the NAN protocol or the OCB protocol with modifications to support broadcast services. FIGS. 4A and 4B describe example modifications to the NAN protocol and OCB protocol, respectively.

The broadcast services transmit unit 120 also may include a security unit 226. For example, the security unit 226 may implement a security protocol or enhancement to the broadcast connectivity protocol. In some implementations, the security unit 226 may cause a public key of the AP 102 to be sent to each recipient STA 104 and 144 that is listening to the broadcast transmissions. The public key may be used by each recipient STA to decrypt the broadcast transmissions that were previously encrypted by the AP 102 using a private key. The public key and private key are cryptographically related such that they form a key pair. If the public key can be used to properly decode the broadcast transmissions, then the STAs 104 and 144 may assume that the broadcast transmissions were only sent by a device (such as the AP 102) that has the private key. The AP 102 maintains the secrecy of the private key as part of the security enhancement. In some other implementations, the security unit 226 may implement the TESLA protocol (or another similar protocol), which uses a time-based verification between a transmitting device (like the AP 102) and a receiving device (like the STAs 104 and 144). The TESLA protocol is an example of a broadcast authentication protocol that uses a low communication and computation overhead, scales to large numbers of receivers, and tolerates packet loss. In some implementations, new signaling may be created for use in a WLAN (such as one associated with IEEE 802.11 or the Wi-Fi Alliance®) to support the use of the TESLA protocol. For example, the AP 102 and the STAs 104 and 144 may be modified such that they can exchange capability information to indicate whether they support the TESLA protocol. If the AP 102 and a STA 104 (or STA 144) both support the use of the TESLA protocol, then the TESLA protocol may be used to establish a secure link for broadcast transmissions. Otherwise, the AP 102 and STA 104 (or STA 144) may fall back to another broadcast connectivity protocol that they both support.

In some implementations, the broadcast services transmit unit 120 also may include a scheduling unit 228. The scheduling unit 228 may determine a schedule for the broadcast transmissions. For example, the schedule may include target wake times (TWTs) based on a synchronized schedule that the STAs 104 and 144 can determine. Other types of scheduling information also may be used. For example, the schedule may include a communication schedule for a concurrent BSS or an overlapping BSS. In some implementations, the schedule may be modified based on transmissions from coexisting technologies (such as satellite or short-range radio frequency systems). In some implementations, the scheduling unit 228 may share or otherwise communicate the schedule to the STAs 104 and 144 so that the STAs may determine the wake-up periods for them to receive broadcast transmissions from the AP 102. For example, the scheduling unit 228 may cause a message to include scheduling information (for example, a scheduling message) to be broadcast via the broadcast transmission unit 222.

In some implementations, the broadcast services transmit unit 120 may include a segment transmission unit 232. For example, the segment transmission unit 232 may divide broadcast information into multiple segments. In some implementations, the segments may be FEC-encoded. The segment transmission unit 232 may cause the segments to be transmitted via one or more wireless broadcast frames (for example, as one or more broadcast PPDUs). The broadcast services transmit unit 120 also may include a feedback processing unit 234 to gather feedback regarding the segments that are received (or not received) by the STAs. In some implementations, the feedback processing unit 234 may use a broadcast “scoreboard” (which also may be referred to as a retransmission controller, delivery status tracker, or other term regarding processed feedback data). For example, the broadcast scoreboard may be used to track which segments have been successfully delivered or which segments would benefit from retransmission in a subsequent wireless broadcast frame. The broadcast scoreboard may be used for other types of analysis, such as determining whether STAs (or how many STAs) are present in the environment and interested in receiving the broadcast transmissions. The broadcast scoreboard may be used to determine the effectiveness of the broadcast services even if some broadcast segments are not retransmitted. For example, a missing broadcast segment may not be retransmitted if the retransmission would be redundant to a future broadcast segment that includes the missing (or updated) broadcast information. In some implementations, the feedback processing unit 234 may use a broadcast scoreboard that represents an aggregate or combined delivery status of the broadcast segments for all the STAs that are receiving the broadcast transmissions (rather than maintaining separate scoreboards for individual STAs).

In some implementations, the broadcast services transmit unit 120 may include a rate adaptation unit 236 which can adjust a data rate (or other parameter or configuration) associated with the broadcast transmissions. For example, the rate adaptation unit 236 may select a different MCS with a higher data rate for the subsequent wireless broadcast frames if the feedback indicates that a threshold percentage of STAs successfully received a previous set of wireless broadcast frames. Alternatively, the rate adaptation unit 236 may select a different MCS with a lower data rate for the subsequent wireless broadcast frames if the feedback indicates that a threshold percentage of STAs did not successfully receive the previous set of wireless broadcast frames.

The STAs 104 and 144 may include a broadcast services receive unit 150 to implement one or more of the broadcast connectivity protocols described herein. The broadcast services receive unit 150 may include a broadcast services application 252, a receiver unit 254, a connectivity unit 256, a power save unit 258, a feedback unit 262, or any combination thereof. For example, the broadcast services receive unit 150 may activate the receiver unit 254 to receive broadcast transmissions in response to detecting that the broadcast services application 252 has been activated or is currently executing. As an example, the broadcast services application 252 may be a video content application for displaying video content in the broadcast transmissions at a sports or concert venue. When the video content application is running, the broadcast services receive unit 150 may activate the receiver unit 254 to observe and receive the broadcast transmissions. In some implementations, the receiver unit 254 may receive broadcast transmissions from multiple APs and combine the broadcast transmissions to recover the broadcast content. The connectivity unit 256 may establish connectivity to the broadcast services. For example, the connectivity unit 256 may implement the modified connectivity protocol that is supported by the connectivity protocol support unit 224. The power save unit 158 may control the power save mode of the STA 104 and 144. For example, the power save unit 258 may determine the deterministic wake-up times for the broadcast services and cause the STA to enter a power save mode for at least some of the other time. The feedback unit 262 may be configured to send feedback in accordance with a broadcast services feedback technique implemented at the AP 102.

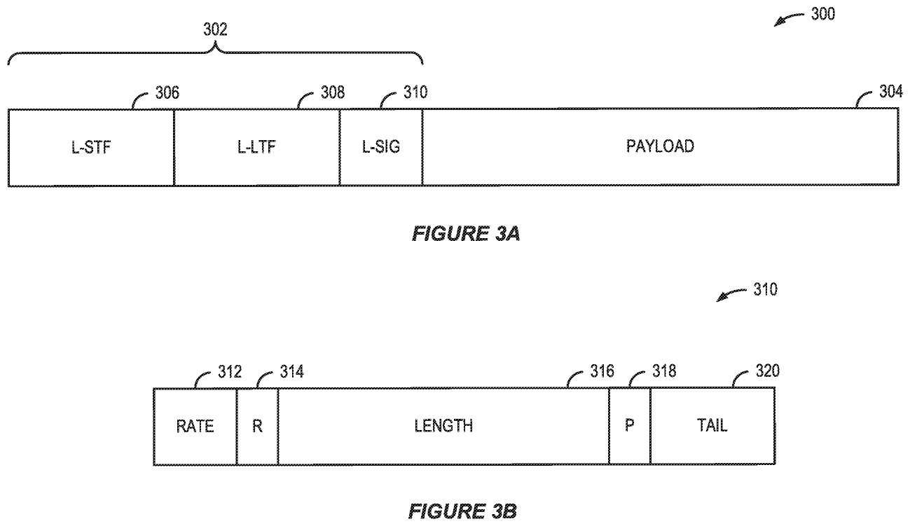

FIG. 3A shows an example protocol data unit (PDU) 300 usable for communications between an AP and a number of STAs. For example, the PDU 300 can be configured as a PPDU. As shown, the PDU 300 includes a PHY preamble 302 and a PHY payload 304. For example, the PHY preamble 302 may include a legacy portion that itself includes a legacy short training field (L-STF) 306, a legacy long training field (L-LTF) 308, and a legacy signaling field (L-SIG) 310. The PHY preamble 302 also may include a non-legacy portion (not shown). The L-STF 306 generally enables a receiving device to perform automatic gain control (AGC) and coarse timing and frequency estimation. The L-LTF 308 generally enables a receiving device to perform fine timing and frequency estimation and also to estimate the wireless channel. The L-SIG 310 generally enables a receiving device to determine a duration of the PDU and use the determined duration to avoid transmitting on top of the PDU. For example, the L-STF 306, the L-LTF 308 and the L-SIG 310 may be modulated according to a binary phase shift keying (BPSK) modulation scheme. The payload 304 may be modulated according to a BPSK modulation scheme, a quadrature BPSK (Q-BPSK) modulation scheme, a quadrature amplitude modulation (QAM) modulation scheme, or another appropriate modulation scheme. The payload 304 may generally carry higher layer data, for example, in the form of medium access control (MAC) protocol data units (MPDUs) or an aggregated MPDU (A-MPDU).

FIG. 3B shows an example L-SIG field 310 in the PDU of FIG. 3A. The L-SIG 310 includes a data rate field 312, a reserved bit 314, a length field 316, a parity bit 318, and a tail field 320. The data rate field 312 indicates a data rate (note that the data rate indicated in the data rate field 312 may not be the actual data rate of the data carried in the payload 304). The length field 316 indicates a length of the packet in units of, for example, bytes. The parity bit 318 is used to detect bit errors. The tail field 320 includes tail bits that are used by the receiving device to terminate operation of a decoder (for example, a Viterbi decoder). The receiving device utilizes the data rate and the length indicated in the data rate field 312 and the length field 316 to determine a duration of the packet in units of, for example, microseconds (μs).

In some implementations, a wireless communication device may use a generic advertisement service (GAS) message to indicate that the wireless communication device supports broadcast services. In some implementations, a wireless communication device may use GAS messages to communicate broadcast messages. The GAS message format may be extended or modified to support broadcast services. For example, a GAS message frame format may be modified or extended to include capability or configuration information related to broadcast services. In some other implementations, a new frame format may created to facilitate broadcast services.

FIG. 4A shows a pictorial diagram of an example wireless communication network 401 using the NAN protocol for broadcast services. According to some aspects, the wireless communication network 401 can be an example of a WLAN. For example, the wireless communication network 401 can be a network implementing at least one of the IEEE 802.11 family of standards. The wireless network 401 may include multiple STAs 144. As described above, each of the STAs 144 also may be referred to as a mobile station (MS), a mobile device, a mobile handset, a wireless handset, an access terminal (AT), a user equipment (UE), a subscriber station (SS), or a subscriber unit, among other possibilities. The STAs 144 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

Before explaining modifications to the neighbor awareness network (NAN) protocol to support broadcast services, it may be useful to describe the NAN protocol. The NAN protocol is defined by the Wi-Fi Alliance (WFA) Neighbor Awareness Networking (also referred to as NAN) standard specification. NAN-compliant devices (hereinafter also simply “NAN devices”) transmit and receive NAN communications (for example, in the form of Wi-Fi packets including frames conforming to an IEEE 802.11 standard such as that defined by the IEEE 802.11-2016 specification or amendments thereof) to and from one another via NAN data links (NDLs) 210 (hereinafter also referred to as “NAN links”). A NAN network generally refers to a collection of NAN devices that share a common set of NAN parameters including: the time period between consecutive discovery windows (DWs), the time duration of the discovery windows, the NAN beacon interval, and the NAN discovery channel(s). A NAN ID is an identifier signifying a specific set of NAN parameters for use within the NAN network. NAN networks are dynamically self-organized and self-configured. Each NAN device may be configured to transmit two types of beacons: NAN discovery beacons and NAN synchronization beacons. When a NAN device is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices passively scan for discovery beacons from other NAN devices. When two NAN devices come within a transmission range of one another, they will discover each other based on such discovery beacons. In traditional implementations, respective master preference values determine which of the NAN devices will become the master device. If a NAN cluster is not discovered, a NAN device may start a new NAN cluster. When a NAN device starts a NAN cluster, it assumes the master role and broadcasts a discovery beacon. Additionally, a NAN device may choose to participate in more than one NAN cluster within a NAN network.

The links between the NAN devices in a NAN cluster are associated with discovery windows—the times and channel on which the NAN devices converge. At the beginning of each discovery window, one or more NAN devices may transmit a NAN synchronization beacon, which is a management frame used to synchronize the timing of the NAN devices within the NAN cluster to that of the master device. The NAN devices may then transmit multicast or unicast NAN service discovery frames directly to other NAN devices within the service discovery threshold and in the same NAN cluster during the discovery window. The service discovery frames indicate services supported by the respective NAN devices.

In some such implementations, a NAN device may, in a service discovery frame, advertise an ability to provide such access point services to other NAN devices. There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN data link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

Some NAN networks may be a peer-to-peer (P2P), ad-hoc or mesh network. NAN devices may communicate directly with each other via P2P wireless links (without the use of an intermediary AP). In some implementations, the mesh network may use a data packet routing protocol, such as Hybrid Wireless Mesh Protocol (HWMP), for path selection. Each NAN device may be configured to relay data for the NAN network such that various NAN devices may cooperate in the distribution of data within the network. As a result, a message can be transmitted from a source NAN device to a destination NAN device by being propagated along a path, hopping from one NAN device to the next until the destination is reached.

Having described the NAN protocol in general, FIG. 4A will be described to explain how the NAN protocol may be modified and used in the IEEE 802.11 network to support broadcast services. For example, the AP 102 may create (or join) a NAN cluster to provide synchronization, service discovery and NDL formation. The AP 102 may establish broadcast communication links 410 as a one-to-many NDL. The AP 102 may advertise the presence of the broadcast communication links 410 (the one-to-many NDL) for the broadcast service. In some implementations, the one-to-many NDL may be used for uplink broadcast frames, downlink broadcast frames, or both. In some implementations, such as a mesh network, the concept of “uplink” or “downlink” may be fluid.

In some implementations, the same one-to-many NDL could be shared by more than one broadcast service. The STAs 144 may participate in the NAN cluster and subscribe to the broadcast service using the broadcast communication links 410 (the one-to-many NDL). In some implementations, a STA may maintain a wireless association with an AP (or another BSS at the AP 102, not shown). For example, the STA may periodically switch between communicating over the NAN network and communicating with the AP. The timing for switching to the NAN network may include deterministic wake-up periods (such as the NAN DWs or the NDL time blocks, NDL-TBs). The STA may use the deterministic wake periods to determine other time periods available for the STA to enter a power-save mode. For example, the NAN protocol defines an interval (such as 512 ms) between each discovery frame and synchronization beacon. For each NDL, there may be one or more scheduled transmissions (such as a time blocks, TB, a paging window, PW, a transmit window, TxW, among other examples). There also may be transmit windows during which no data is sent, and those TxWs may be available for the STA to enter a power-save mode.

FIG. 4A also shows a potential extension for broadcast services in which a mesh network capability of the NAN protocol may be used. For example, a first STA 144′ may use another NDL 412 to a second STA 446 to relay broadcast information that it receives from the AP 102 via the broadcast communication 410.

There may be multiple NDLs in operation in the NAN network. A STA may determine which NDL(s) to join based on the type of content desired. For example, a STA that is executing an application to receive broadcast video may join an NDL that provides the broadcast video. Similarly, the STA may execute an application to receive score updates or new and may join an NDL associated with that application. A STA may select which NDL(s) or may join an AP for unicast (or both) based on the applications executing at the STA. For example, a STA may maintain a concurrent association with an AP for unicast traffic (such as social networking or news download) and may listen to broadcast traffic (via an NDL) for broadcast applications (such as audio or video).

FIG. 4B shows a pictorial diagram in which a NAN network 420 may include different NDLs to support different applications or services. For example, the NAN network 420 may include multiple STAs 144. Within the NAN network 420, there may exist different NDLs (such as a first NDL 422, a second NDL 424 and a third NDL 426). Each NDL may be associated with different applications or services. For example, the first NDL 422 may provide video broadcast services for a sporting event, while the second NDL 424 may provide other content or broadcast information. A STA may determine which NDL(s) to join based on what types of content the STA is interested in receiving. In some implementations, the NDLs may form a NAN data link cluster (NDC) or may be referred to as separate NDL networks. In some implementations, the NDLs may operate on different channels or different time blocks (or both).

FIG. 4C shows a pictorial diagram of an example wireless communication network using an independent Basic Service Set (IBSS) for broadcast services. An IBSS is a mode of communication in which peer devices (such as STAs 144) can communicate directly with each other. Rather than using a unique BSSID (such as for an infrastructure mode BSS), an independent BSS may use a universal or group address. The broadcast signals 116 may be transmitted as IBSS-addressed frames 430 over the IBSS from any of the peer devices. It should be apparent the that the peer devices in the IBSS may include APs, STAs, or any combination of APs and STAs. In an IBSS, each of the participating peer devices may have a loose association with one or more other peer devices.

An initiator of the IBSS (such as an AP or a lead STA 432) may set up the IBSS and broadcast frames using the IBSS mode. Any devices (such as STAs 144) interested in receiving the broadcast frames may operate in an IBSS mode. For example, a STA may enable IBSS mode in response to detecting that a broadcast application is launched on the STA. In some implementations, the STA may maintain a concurrent association (to an AP operating in infrastructure mode or OCB) while periodically receiving the broadcasts via the IBSS.

In some implementations, each STA participating in IBSS mode are expected to contend to send a beacon transmission. However, this may lead to beacon collisions or hidden beacons in a larger network. In some implementations, the beacon behavior in a IBSS may be modified when the IBSS is used for broadcast services. For example, the initiator of a broadcast IBSS may beacon while the recipients of the broadcast may refrain from sending beacons in the IBSS mode. Other techniques may be used to determine which recipients (if any) may send beacons to maintain synchronization in the IBSS.

In some implementations, the IBSS mode may be modified for use with broadcast services such that it would not be confused with a traditional IBSS. For example, the addressing, association, or other security feature may be used to prevent legacy STAs from attempting to join the IBSS unless they are interested in receiving the broadcast transmissions.

In some implementations, the initiator may advertise a Broadcast TWT schedule or other schedule that is useable by the STAs to determine potential time periods of inactivity during which the STA may enter a power-save mode. The Broadcast TWT may be included as an element in the beacon frame.

FIG. 4D shows a pictorial diagram of an example wireless communication network 404 using the OCB protocol for broadcast services. The OCB protocol, defined in IEEE 802.11p, may permit STAs to transmit data frames outside of the context of a BSS. For example, in the traditional use case for IEEE 802.11p, the STA would not be a member of a BSS. The OCB protocol may expect STAs to communicate directly over a wireless medium without the latency that may be associated with establishing a BSS. A setting in a management frame is used by a STA to indicate that it supports OCB protocol. Data frames have a wildcard BSS identifier (BSSID) value in a BSSID field that would otherwise identify a BSS. For example, the wildcard BSSID may be all “1s.”

In the example wireless communication network 404, the AP 102 may transmit broadcast frames 440 with data frames formatted according to the OCB protocol. For example, the BSSID field may be set to a wildcard BSSID value. Alternatively, another reserved BSSID value may be used to indicate that the broadcast frames 440 contain broadcast data. Each of the STAs 144 may receive the broadcast frames 440. In some implementations, the AP 102 may not establish a BSS and may refrain from transmitting beacon frames or probe response frames.

A STA 144 may enable an OCB mode when the STA is interested in receiving and decoding the broadcast data. For example, if a broadcast services application is executing or attentive, then the STA 144 may turn on the OCB mode on its receiver unit.

In some implementations, the AP 102 may advertise a broadcast target wake time (TWT) schedule or may schedule a broadcast burst with deterministic periodicity. The STAs may use the schedule to determine wake-up times for the broadcast frames 440. The STAs may enter a power save mode during other time periods. In some implementations, the timing and synchronization may be provided by another protocol. For example, IEEE 802.11p time advertisement frame may provide time information. In some implementations, a NAN-based synchronization may be used in a modified use of the OCB broadcast frames. In some implementations, the TWT schedule may be included in a management frame (such as a timing advertisement frame or action frame) using the OCB protocol.

FIG. 4D also shows a potential implementation in which a STA 144′ may maintain a wireless association 230 (such as with a BSS) with another AP 440. For example, the STA 144′ may support concurrent utilization of the OCB mode (for receiving the broadcast frames 440 from the AP 102) and a wireless association mode (for communicating with the BSS managed by the AP 440). In FIG. 4D, the other AP 440 is shown as a separate AP from the AP 102 that supports broadcast services. However, it is possible for the same AP to support broadcast services (using OCB protocol) while also operating a BSS for unicast communications. The APs (such as AP 102 and AP 440) may be co-located in the same hardware or may be implemented in separate hardware, such as different apparatuses. Alternatively, the AP 102 may be dedicated to broadcast services, while another AP (such as the AP 440) may be dedicated to non-broadcast traffic. In some implementations, the BSS may be established on a different wireless channel as the OCB broadcast traffic. Alternatively, the AP may establish the BSS and the OCB broadcast traffic using different timing on the same wireless channel.

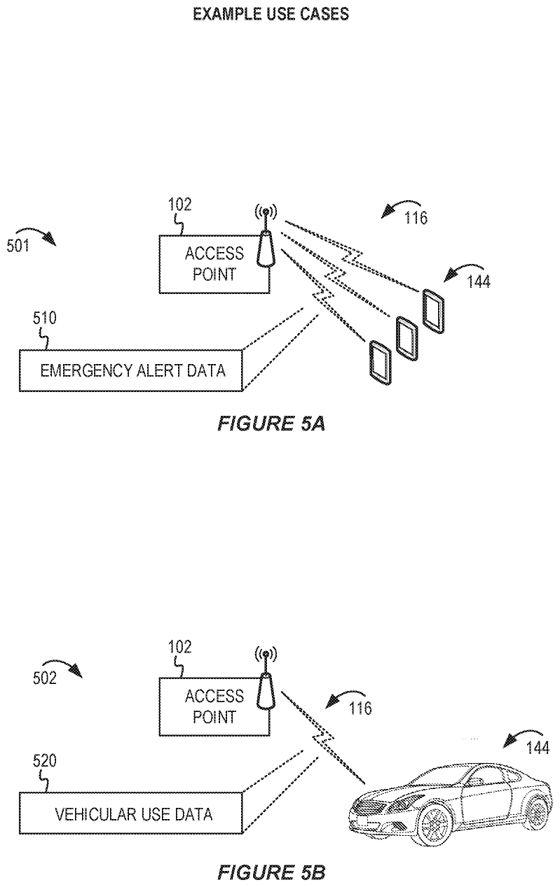

FIG. 5A shows a pictorial diagram of an example use case 501 of broadcast services for emergency alert data 510. For example, the AP 102 may send broadcast signals 116 that include emergency alert data 510 to the STAs 144. An example of the emergency alert data 510 may include the emergency alert service (EAS) defined by IEEE 802.11u. Other examples may include first responder alerts, retransmitted broadcasts from a cellular or satellite alert system, among other examples. In some implementations, the AP 102 may advertise an Emergency Alert Identifier element in a Beacon or Probe Response frame. The emergency alert data 510 may include an Emergency Alert uniform resource identifier (URI) or an access network query protocol (ANQP) element. The URI may identify the location from where the EAS message can be retrieved. The emergency alert data 510 may include a hash of the message so that a STA can determine if it has already retrieved the alert or whether to download the new one. In some implementations, a bit in an Advertisement Protocol element may indicate if the emergency alert data 510 can be retrieved in the pre-associated state. For example, the bit may be a Pre-Association Message Exchange BSSID Independent (PAME-BI) bit.

FIG. 5B shows a pictorial diagram of an example use case 502 of broadcast services for vehicular use data 520. For example, the AP 102 may send broadcast signals 116 that include the vehicular use data 520 to the STAs 144. In some implementations, the STAs 144 may be a personal information device (such as a portable device, smartphone, or tablet) or may be on-board equipment (OBE, such as a mobile device installed in a light vehicle, commercial vehicle, rail car, bus, subway unit, among other examples). The AP 102 may be an AP in the vehicle or may be road side equipment (RSE, such as fixed equipment installed on the roadside). For example, the AP 102 may be portable or temporary for some installations such as work zones, detours, and accident scenes. Examples of the vehicular use data 520 may include lane closure information, reduced speed notification, a map of a parking lot, information about a train approaching a highway-rail intersection, among other examples. Other examples of the vehicular use data 520 may include driving collision avoidance (regarding another vehicle or a non-vehicle obstacle), road hazard information, blind spot warning information, do not pass warning information among other examples.

In some implementations, the vehicular use data 520 may benefit from broadcast connectivity protocol that uses a no-association, pre-association, light-association or fast-association connectivity scheme. For example, vehicles may have sufficient mobility that the latency involved with establishing a wireless association may be impractical. A full wireless association may involve an exchange of multiple messages before application data is communicated. However, using a no-association, pre-association, light-association or fast-association connectivity scheme may avoid or reduce the exchange of the messages to establish a full wireless association. Examples of fast-association may include IEEE 802.11aq and fast initial link setup (FILS).

Furthermore, due to the mobility of a vehicle-type STA, the AP 102 may modify the broadcast services based on Doppler or Dwell time (in source coverage). For example, to address the potential doppler effect, the a source transmitter (such as the AP 102) may adjust the MCS or may have periodic midambles (or other synchronizations portions) in the PPDU to help the receiving STA maintain synchronization. To address dwell time, there could be multiple sources along the direction of motion and each source may continuously broadcast small portions of information or small segments of the frame. A receiving STA may consolidate the received portions or segments to receive the full broadcast transmission. In some implementations, forward error correction (FEC), Raptor codes, or some other redundancy protocol may be used to provide reliable delivery of the broadcast transmission. For example, the broadcast transmission may be encoded using FEC into multiple segments of data. As long as the STA can receive S segments, the STA may be able to reconstruct the original stream of n bytes of the broadcast transmission.

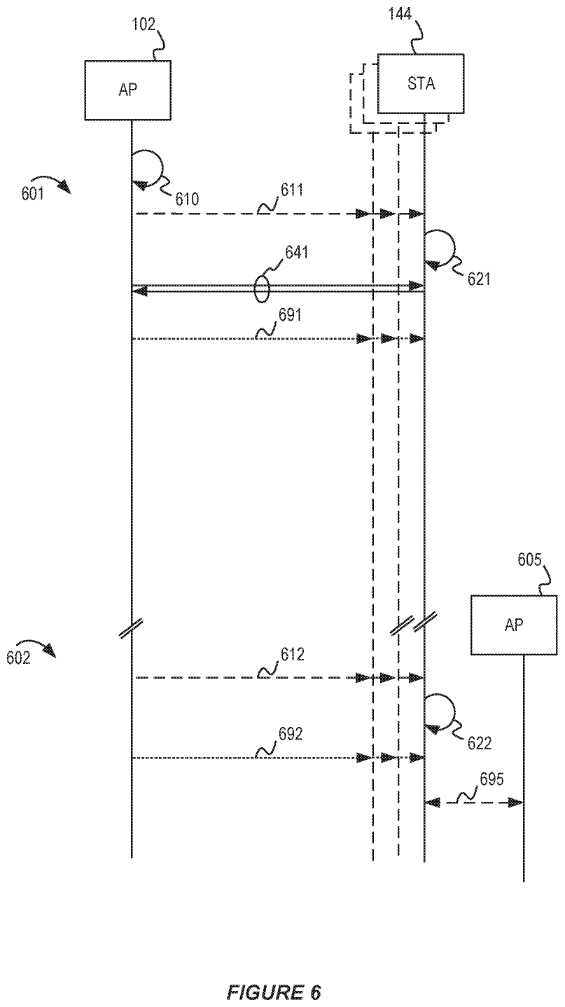

FIG. 6 shows a message flow diagram illustrating example broadcast connectivity techniques. The message flow diagram shows two different broadcast connectivity protocols 601 and 602 which can be used between an AP 102 and STAs 144. Although shown together in FIG. 6, the AP 102 may implement only one or both of the broadcast connectivity protocols 601 and 602.

Using a first broadcast connectivity protocol 601, the AP 102 establishes or joins a NAN cluster at process 610. The AP 102 may send a first message 611 (such as a broadcast management message or discovery information) that advertises the broadcast services provided by the AP 102. At process 621, a STA 144 may determine that a broadcast services application is executing. Using messages 641, the STA 144 and the AP 102 may exchange information to establish a broadcast communication link. For example, the messages 641 may be formatted according to the NAN protocol and may set up a subscription to a one-to-many NDL hosted by the AP 102, however, other subscription or session establishment procedures may be used. Thereafter, the AP 102 may transmit broadcast frames 691 which the STAs 144 receive and process.

Using a second broadcast connectivity protocol 602, the AP 102 transmits a first message 612 (such as a broadcast management message or discovery information) that advertises the broadcast services provided by the AP 102. At process 622, a STA 144 may determine that a broadcast services application is executing. Thereafter, the STA 144 may receive, and process, broadcast frames 692 transmitted by the AP 102. For example, the broadcast frames 692 may be OCB broadcast frames. In some implementations, the STA 144 may maintain a unicast communication link 695 with another AP 605 while receiving the broadcast frames 692.

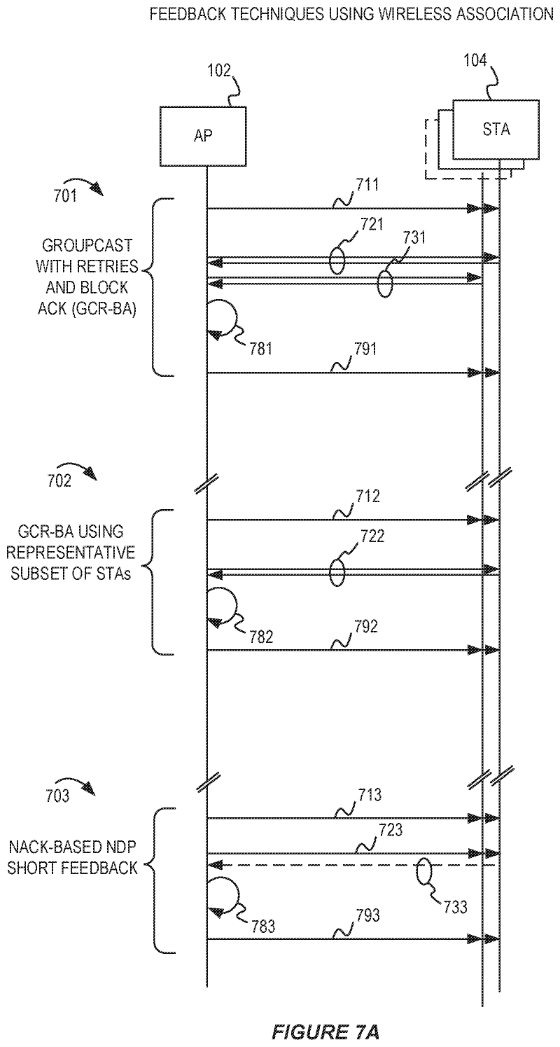

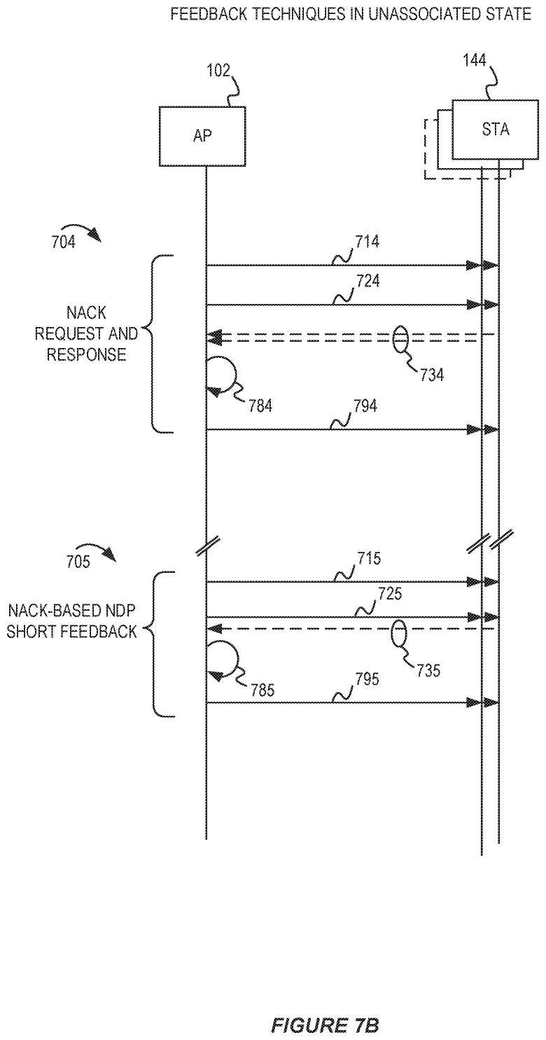

FIG. 7A shows a message flow diagram illustrating example broadcast services feedback techniques using wireless association. The message flow diagram shows three different broadcast services feedback techniques 701, 702 and 703 which can be used between an AP 102 and STAs 104 that have a wireless association to the AP 102. Although shown together on FIG. 7A, the AP 102 may implement only one, only two, or all three of the broadcast services feedback techniques 701, 702 and 703.

A first broadcast services feedback technique 701 is based on IEEE 802.11aa. In the first broadcast services feedback technique 701, the AP 102 may send one or more wireless broadcast frames 711 to the STAs 104. The wireless broadcast frames 711 may be referred to as a groupcast with retry (GCR) because each of the messages is sent to multiple recipient STAs concurrently, and includes a retry mechanism based on the feedback. To obtain the feedback, the AP 102 may send a query and receive a block acknowledgement (BA) message from each of the STAs 104. For example, message exchange 721 may be a query and response to and from, respectively, a first STA, and the message exchange 731 may be a query and response for a second STA. This feedback scheme may be referred to as a GCR-with-block-ACK (or GCR-BA). GCR-BA differs from other techniques in IEEE 802.11aa, such as Robust AV streamlining (which is based on directed multicast service, or DMS, in which broadcast transmissions are duplicated for each recipient) or GCR with unsolicited retries (GCR-UR, in which the AP retransmits a multicast frame several times for redundancy). At process 781, the AP 102 may determine which wireless broadcast frames 791 to retransmit. While this technique provides a reliable delivery and feedback mechanism, the technique may not be scalable when a larger number of recipient STAs are receiving the groupcast messages. Some modifications to the IEEE 802.11aa (proposed in 802.11ax and referred to as GCR multiuser block acknowledgement request, or GCR MU-BAR) may enable feedback from up to 37 STAs concurrently, where each STA provides feedback in a separate 26 tone resource unit (26-RU) portion of an 80 MHz channel. However, even with GCR MU-BAR, the amount of overhead associated with obtaining feedback from all STAs may be untenable in a wireless network in which a large number of STAs are receiving the broadcast frames.

In a second broadcast services feedback technique 702, the AP 102 may send one or more wireless broadcast frames 712 to the STAs 104. Different from the first broadcast services feedback technique 701, in the second broadcast services feedback technique 702, the AP 102 may seek to obtain feedback from only a subset of the STAs that are receiving the broadcast transmissions. For example, a representative subset of the STAs may be designated to send feedback. In some implementations, the representative subset of STAs are designated based on their location, priority, signal strength, or by random selection. In some implementations, the representative subset may be designated by the other STAs in a group, or may be selected and designated by the AP 102. Various algorithms may be used to select which STAs are designated as belonging to the representative subset of STAs. The designated STAs may be referred to as “leader” and the technique may be referred to as a “leader-based” ACK mechanism because the leader provides feedback as a representative sample of multiple STAs. The second broadcast services feedback technique 702 provides a highly scalable solution for obtaining Block-ACK feedback regarding the broadcast services while managing the amount of overhead associated with obtaining the feedback. The quantity of designated STAs may be selected based on a target resource overhead allocated for feedback and the total quantity of STAs that are subscribed to the broadcast services. In the example shown in FIG. 7A, the message exchange 722 may include a query and an associated response from a first STA that is designated to provide feedback for the STAs 104. At process 782, the AP 102 may determine which wireless broadcast frames 792 to retransmit based on the GCR-BA message from the first STA. In some implementations, the AP 102 may extrapolate a broadcast scoreboard (retransmission control information) for all the subscribed STAs based on the feedback obtained from the designated STAs.

A third broadcast services feedback technique 703 uses NACK-based feedback. The AP 102 may send one or more wireless broadcast frames 713 to the STAs 104. The wireless broadcast frames 713 may include multiple segments of the broadcast information. After transmitting a quantity of segments (such as based on a segment window size), the AP 102 may broadcast a NACK request message 723. The NACK request message 723 may solicit feedback from any STAs that have missed a threshold quantity of segments. In some implementations, the NACK request message 723 may include a first value indicating the threshold quantity of broadcast segments. In some implementations, each STA may determine whether to send feedback based on how many broadcast segments have been received compared to the threshold quantity of broadcast segments. If the STA needs to send feedback, the STA may determine a random time within a duration defined by a network allocation vector (NAV) available for multiple feedback messages from multiple STAs. The STA may then send the feedback at the random time to avoid collision with a transmission from another STA. In FIG. 7A, the first STA may send a NACK feedback message 733. At process 783, the AP 102 may determine which wireless broadcast frames 793 to retransmit based on the NACK feedback message 733 from the first STA.

In some implementations, a variation of the third broadcast services feedback technique 703 may use a short feedback message, such as a null data packet (NDP) feedback report. The NDP feedback report provides a mechanism for the AP 102 to collect short feedback messages from a very large number of STAs in an efficient manner. The feedback messages (for example, in the form of resource requests) may be sent without data payloads in response to a Trigger frame (such as the NACK request message 723) transmitted by the AP 102. Each bit (or group of bits) in the NDP short feedback message may represent different segments in the segment window size). For example, the bits may be associated with different NACK time periods relative to a start time for the NDP short feedback message. Each STA may indicate which broadcast segments have not received by the STA by transmitting radio frequency (RF) energy during the corresponding one or more NACK time periods associated with the missing segment. This feedback technique may be referred to as a “voting” type scheme because all the STAs can concurrently contribute RF energy to indicate which broadcast segments they have missed. In some implementations, the short feedback message may include different bit positions (which correspond to NACK time periods) for each NACK bit. The short feedback message may include at least one bit value that is reinforced by radio energy contributed by multiple STAs. The AP 102 may detect an amount of RF energy during each the one or more NACK time periods. If the RF energy for a particular NACK time period is above a threshold amount, the AP 102 may determine to retransmit the broadcast segment associated with that NACK time period.

The above described broadcast services feedback techniques 701, 702 and 703 may be used by STAs that have a wireless association with the AP 102. In some implementations, the STAs may have an affiliation status (rather than a full wireless association) with the AP 102. For example, the AP 102 may support broadcast services for STAs without performing a full authentication and wireless session establishment. Rather, the affiliation status may be based on an indication from the STA to the AP 102 that the STA is listening to the broadcast transmissions from the AP 102. The indication may be based on a discovery frame, service request frame, or other short message. Any type of message (including newly defined messages or message types) may be created or modified to carry the indication or to create the affiliation status.

FIG. 7B shows a message flow diagram illustrating example broadcast services feedback techniques in an unassociated state. STA 144 in the unassociated state do not have a wireless association with the AP 102. In some implementations, the STAs 144 may have only an affiliation status, as described in FIG. 7A. In other implementations, the STAs 144 may be unknown to the AP 102 but may still receive the broadcast transmissions from the AP 102. The broadcast services feedback techniques 704 and 705 in FIG. 7B may be used regardless of whether the AP 102 recognizes the STAs 144 as being wirelessly associated with a BSS managed by the AP 102.

In a fourth broadcast services feedback technique 704 using a NACK-based feedback scheme, the AP 102 may send one or more wireless broadcast frames 714 to the STAs 144. The wireless broadcast frames 714 may include multiple segments of the broadcast information. After transmitting a quantity of segments (such as based on a segment window size), the AP 102 may broadcast a NACK request message 724. The NACK request message 724 may solicit feedback from any STAs that have missed a threshold quantity of segments. If the STA 144 needs to send feedback, the STA 144 may determine a random time within a duration defined by a NAV available for multiple feedback messages from multiple STAs, and send the feedback at the random time to avoid collision with a transmission from another STA. In FIG. 7B, two of the STAs 144 send NACK feedback messages 734. At process 784, the AP 102 may determine which wireless broadcast frames 794 to retransmit based on the NACK feedback messages 734.

A fifth broadcast services feedback technique 705 uses a short feedback scheme, such as the NDP feedback report described above. After sending one or more wireless broadcast frames 715, the AP 102 may transmit a NACK request message 725. Any STAs that have missing broadcast segments may report (vote) by contributing RF energy in NACK time periods that correspond to the missing broadcast segments. At process 785, the AP 102 may detect an amount of RF energy during each the one or more NACK time periods. Based on the amount of RF energy during the NACK time periods, the AP 102 may determine which wireless broadcast frames 795 to retransmit.

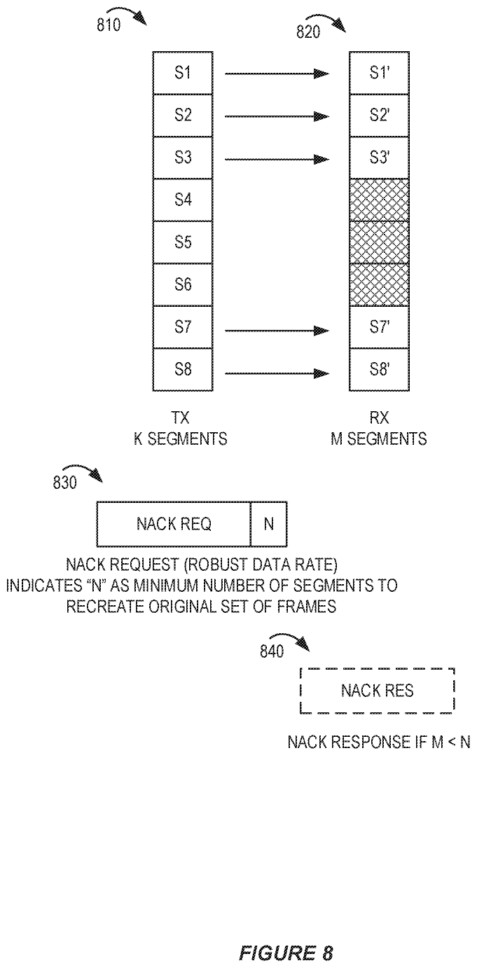

FIG. 8 shows an example of redundant broadcast and NACK feedback. FIG. 8 shows eight broadcast segments 810 that are prepared and transmitted by an AP. The broadcast segments 810 may be formed from source broadcast information. The broadcast segments may include FEC encoding and/or redundancy enabling the STA to recover the source broadcast information even when the STA receives a subset of the broadcast segments 810. Although the whole broadcast transmission may include S segments, the STA may be capable of recovering the source broadcast information if the STA receives at least N segments (where N is less then S). In the example of FIG. 8, the STA may receive M (for example, five) segments 820.

The NACK request message 830 may be sent from the AP to the STA using a robust data rate (for example, a low data rate with high delivery reliability). In some implementations, the NACK request message 830 may include a first value or other indicator. The first value may inform the STA of the minimum number of segments Sₘᵢₙ that can be used to recover the source broadcast information. If the quantity M of the received segments 820 is greater than Sₘᵢₙ, the STA does not need to send a NACK response 840. However, if the quantity M of the received segments 820 is less than Sₘᵢₙ, the STA may send the NACK response 840.

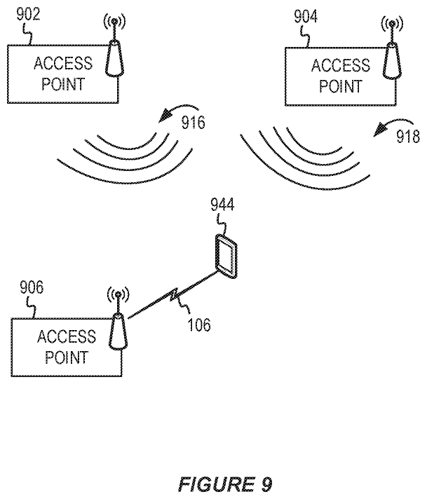

FIG. 9 shows a pictorial diagram of example scenarios with multiple APs. In a first scenario, a STA 944 may receive wireless broadcast frames 916 and 918 from multiple APs (such as APs 902 and 904). The STA 944 may combine the segments received in the wireless broadcast frames 916 and 918 to recover the broadcast information. For example, in a sports or concert venue, the STA 944 may be capable of receiving the same video content from multiple APs. By combining the wireless broadcast frames 916 and 918, the STA 944 may use wireless broadcast frames 918 from an alternate AP 904 to fill gaps in the missing broadcast segments that were corrupt or missing from a primary AP 902. Although labeled as alternate and primary, in some implementations, the APs 902 and 904 may be equally weighted. Furthermore, in some implementations, the APs may duplicate the same broadcast transmissions, while in other implementations, the APs may send different portions of the broadcast information. When preparing the feedback, the STA 944 may use the combined wireless broadcast frames 916 and 918 to determine which broadcast segments (if any) were missing.

In another scenario, the STA 944 may maintain a wireless association (via a communication link 106) to a first AP 906. For example, the STA 944 may be both wirelessly associated with the first AP 906 (such as for unicast traffic or WLAN access) and also receive the wireless broadcast frames 916 and 918 from the APs 902 and 904 with which the STA 944 does not have a wireless association. In some implementations, the STA 944 may switch between different wireless channels (or timeslots) utilized by the first AP 906 and the APs 902 and 904. For example, the STA 944 may periodically observe a first wireless channel for the wireless broadcast frames 916 from the AP 902 while maintaining a communication link 106 with the first AP 906 via another wireless channel.

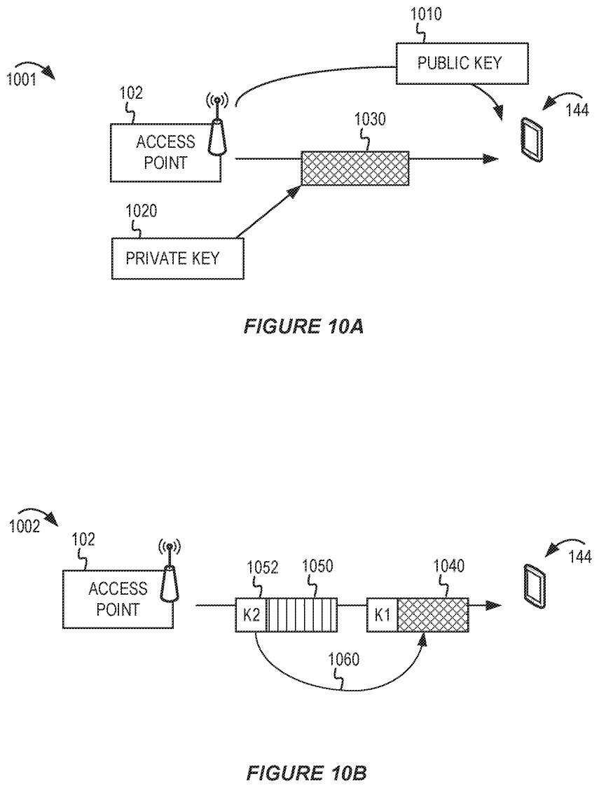

FIG. 10A shows a pictorial diagram of an example security protocol 1001. The security protocol 1001 is based on public key infrastructure (PKI) cryptography. The security protocol 1001 involves the use of a public key 1010 and a private key 1020. The public key 1010 and the private key 1020 are cryptographically-related as an asymmetric key pair such that the public key 1010 can be used to decrypt messages that have been encrypted by the private key 1020. In FIG. 10A, a STA 144 may obtain the public key 1010 while the AP 102 may keep the private key 1020 as a secret. There may be different ways for the STA 144 to obtain the public key 1010. For example, the AP 102 may provide the public key 1010 during a setup phase, association, or subscription protocol. The public key 1010 may be exchanged during the setup of an NDL or may be provided via an OCB broadcast. The public key 1010 may be provided in a FILS Public Key element. Alternatively, the STA 144 may obtain the public key 1010 from a central key repository at a location different from the AP 102. The AP 102 may encrypt messages (such as a broadcast frame 1030) using the private key 1020. The STA may decrypt the messages using the public key 1010.

Other example security protocols may include PKI and keys. For example, a broadcast message may be signed or certified using the private key. The certificates or signature may be in lieu of, or in addition to, encrypting the message.

FIG. 10B shows a pictorial diagram of another example security protocol 1002. The security protocol 1002 is based on the TESLA broadcast authentication protocol. In the security protocol 1002, the AP 102 may attach a message authentication code (MAC) to each broadcast frame. The MAC may be computed with a key Kₓ that is generated at the AP 102 (and known only to the AP 102) at the time the MAC is computed. The STA 144 may buffer a received broadcast frame until a subsequent broadcast frame is received. The subsequent broadcast frame may include a disclosure of the key Kₓ that was previously used to compute the MAC. The STA 144 may be able to authenticate the buffered broadcast frame using the key Kₓ in the subsequent broadcast frame. Each broadcast frame may have a different MAC based on a subsequently disclosed key which can be used to authenticate the broadcast source. Time synchronization may be used to determine the appropriate key Kₓ for each MAC. In FIG. 10B, a first frame may have a first MAC 1040 which is computed using a key K₂. The first frame may have a key K₁ that was used to compute an earlier MAC (not shown) included in an earlier frame (also not shown). In a second frame, the key K₂ 1052 may be disclosed. The second frame also may have a second MAC 1050 which can be authenticated by a later disclosed key (not shown). Shown as arrow 1060, the key K₂ 1052 may be used to authenticate the first MAC 1040.

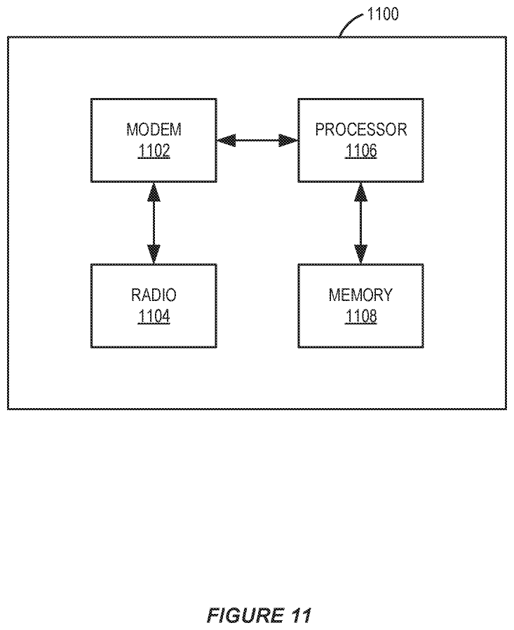

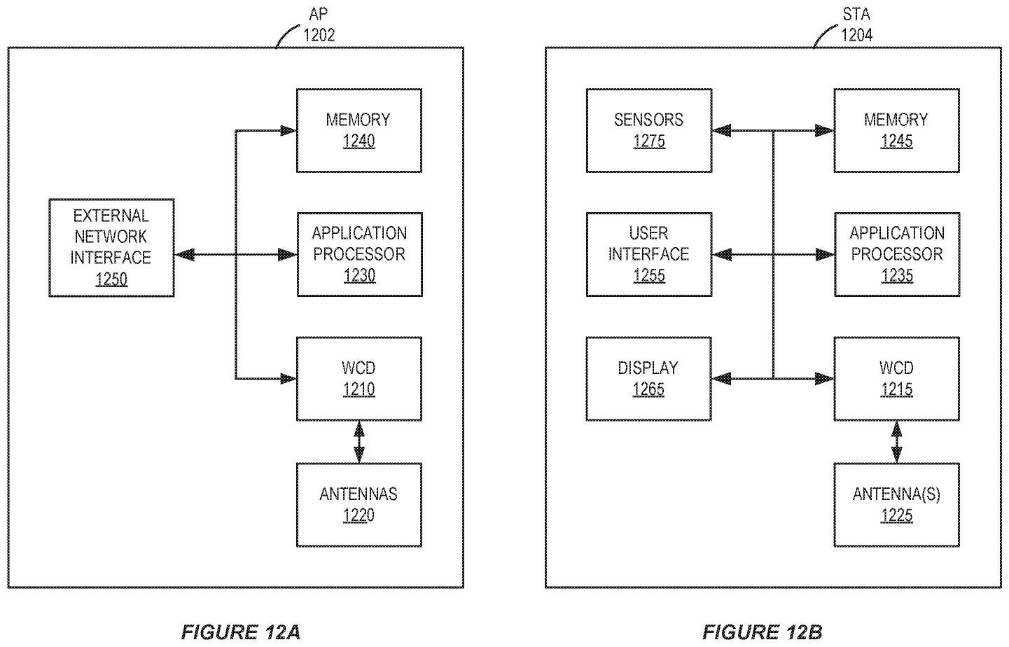

FIG. 11 shows a block diagram of an example wireless communication device 1100. In some implementations, the wireless communication device 1100 can be an example of a device for use in a STA such as one of the STAs 104, 144 described herein. In some implementations, the wireless communication device 1100 can be an example of a device for use in an AP such as the AP 102 described herein. The wireless communication device 1100 is capable of transmitting (or outputting for transmission) and receiving wireless communications (for example, in the form of wireless packets). For example, the wireless communication device can be configured to transmit and receive packets in the form of physical layer convergence protocol (PLCP) protocol data units (PPDUs) and Media Access Control (MAC) protocol data units (MPDUs) conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 1100 can be, or can include, a chip, system on chip (SoC), chipset, package or device that includes one or more modems 1102, for example, a Wi-Fi (IEEE 802.11 compliant) modem. In some implementations, the one or more modems 1102 (collectively “the modem 1102”) additionally include a WWAN modem (for example, a 3GPP 4G LTE or 5G compliant modem). In some implementations, the wireless communication device 1100 also includes one or more radios 1104 (collectively “the radio 1104”). In some implementations, the wireless communication device 1106 further includes one or more processors, processing blocks or processing elements 1106 (collectively “the processor 1106”) and one or more memory blocks or elements 1108 (collectively “the memory 1108”).

The modem 1102 can include an intelligent hardware block or device such as, for example, an application-specific integrated circuit (ASIC) among other possibilities. The modem 1102 is generally configured to implement a PHY layer. For example, the modem 1102 is configured to modulate packets and to output the modulated packets to the radio 1104 for transmission over the wireless medium. The modem 1102 is similarly configured to obtain modulated packets received by the radio 1104 and to demodulate the packets to provide demodulated packets. In addition to a modulator and a demodulator, the modem 1102 may further include digital signal processing (DSP) circuitry, automatic gain control (AGC), a coder, a decoder, a multiplexer and a demultiplexer. For example, while in a transmission mode, data obtained from the processor 1106 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 1104. In implementations involving beamforming, the modulated symbols in the respective spatial streams are precoded via a steering matrix prior to their provision to the IFFT block.

While in a reception mode, digital signals received from the radio 1104 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 1106) for processing, evaluation or interpretation.

The radio 1104 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may in turn be coupled to one or more antennas. For example, in some implementations, the wireless communication device 1100 can include, or be coupled with, multiple transmit antennas (each with a corresponding transmit chain) and multiple receive antennas (each with a corresponding receive chain). The symbols output from the modem 1102 are provided to the radio 1104, which then transmits the symbols via the coupled antennas. Similarly, symbols received via the antennas are obtained by the radio 1104, which then provides the symbols to the modem 1102.

The processor 1106 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 1106 processes information received through the radio 1104 and the modem 1102, and processes information to be output through the modem 1102 and the radio 1104 for transmission through the wireless medium. For example, the processor 1106 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 1106 may generally control the modem 1102 to cause the modem to perform various operations described above.

The memory 1104 can include tangible storage media such as random-access memory (RAM) or read-only memory (ROM), or combinations thereof. The memory 1104 also can store non-transitory processor- or computer-executable software (SW) code containing instructions that, when executed by the processor 1106, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

In some implementations, the wireless communication device 1100 may include a broadcast services transmit unit (not shown). The broadcast services transmit unit may be similar to the broadcast services transmit unit 120 described with reference to FIG. 2 and may implement any of the broadcast services feedback techniques described herein. In some implementations, the broadcast services transmit unit may be implemented by a processor 1106 and a memory 1108. The memory 1108 can include computer instructions executable by the processor 1106 to implement the functionality of the broadcast services transmit unit. Any of these functionalities may be partially (or entirely) implemented in hardware or on the processor 1106.

In some implementations, the wireless communication device 1100 may include a broadcast services receive unit (not shown). The broadcast services receive unit may be similar to the broadcast services receive unit 150 described with reference to FIG. 2 and may implement any of the broadcast services feedback techniques described herein. In some implementations, the broadcast services receive unit may be implemented by a processor 1106 and a memory 1108. The memory 1108 can include computer instructions executable by the processor 1106 to implement the functionality of the broadcast services receive unit. Any of these functionalities may be partially (or entirely) implemented in hardware or on the processor 1106.

FIG. 12A shows a block diagram of an example AP 1202. For example, the AP 1202 can be an example implementation of the AP 102 described herein. The AP 1202 includes a wireless communication device (WCD) 1210. For example, the wireless communication device 1210 may be an example implementation of the wireless communication device 1100 described with reference to FIG. 11. The AP 1202 also includes multiple antennas 1220 coupled with the wireless communication device 1210 to transmit and receive wireless communications. In some implementations, the AP 1202 additionally includes an application processor 1230 coupled with the wireless communication device 1210, and a memory 1240 coupled with the application processor 1230. The AP 1202 further includes at least one external network interface 1250 that enables the AP 1202 to communicate with a core network or backhaul network to gain access to external networks including the Internet. For example, the external network interface 1250 may include one or both of a wired (for example, Ethernet) network interface and a wireless network interface (such as a WWAN interface). Ones of the aforementioned components can communicate with other ones of the components directly or indirectly, over at least one bus. The AP 1202 further includes a housing that encompasses the wireless communication device 1210, the application processor 1230, the memory 1240, and at least portions of the antennas 1220 and external network interface 1250.

FIG. 12B shows a block diagram of an example STA 1204. For example, the STA 1204 can be an example implementation of the STA 104, 144 described herein. The STA 1204 includes a wireless communication device 1215. For example, the wireless communication device 1215 may be an example implementation of the wireless communication device 1100 described with reference to FIG. 11. The STA 1204 also includes one or more antennas 1225 coupled with the wireless communication device 1215 to transmit and receive wireless communications. The STA 1204 additionally includes an application processor 1235 coupled with the wireless communication device 1215, and a memory 1245 coupled with the application processor 1235. In some implementations, the STA 1204 further includes a user interface (UI) 1255 (such as a touchscreen or keypad) and a display 1265, which may be integrated with the UI 1255 to form a touchscreen display. In some implementations, the STA 1204 may further include one or more sensors 1275 such as, for example, one or more inertial sensors, accelerometers, temperature sensors, pressure sensors, or altitude sensors. Ones of the aforementioned components can communicate with other ones of the components directly or indirectly, over at least one bus. The STA 1204 further includes a housing that encompasses the wireless communication device 1215, the application processor 1235, the memory 1245, and at least portions of the antennas 1225, UI 1255, and display 1265.

As described above, broadcast services may use different connectivity protocols than previously used with protocols based on WLAN wireless associations. For example, the time and messaging associated with establishing a wireless association may be impractical for broadcast services. For example, when a large number of STAs may consume the broadcast wireless transmissions, it may be impractical to solicit positive acknowledgement feedback from the STAs. In some deployments, the establishment of broadcast communication links may benefit from new types of connectivity protocols. For example, it may be desirable to have a measurement of the effectiveness of the broadcast transmission so that the broadcast services can be optimized for the wireless resources.

Various implementations relate generally to wireless communication. Some implementations more specifically relate to broadcast services in a wireless network. In some implementations, a communication protocol may be modified or adapted to enable broadcast transmissions. A non-association, pre-association, light-association, or fast-association scheme may be used to convey broadcast information without establishing a full wireless association between an AP and a STA. In some implementations, a NAN protocol or an OCB protocol may be used for discovery, synchronization, or subscription of broadcast services. The broadcast services feedback techniques described in this disclosure can enable an AP to obtain feedback from multiple STAs. In some implementations, the feedback may be used by the AP to determine which broadcast segments to retransmit. Additionally or alternatively, the feedback may be used to optimize the wireless parameters (such as data rate, MCS, FEC, among other examples) for subsequent broadcast transmissions.

Some implementations more specifically relate to the use of NACK-based feedback by STAs. In some implementations, the NACK-based feedback may be used by STAs that do not have a wireless association with the AP. The NACK-based feedback may reduce the overhead associated with feedback from multiple STAs. In some implementations, a representative subset of the STAs may provide feedback as a representative sample of multiple STAs. In some implementations, the NACK-based feedback may use an NDP short feedback message in which multiple STAs can concurrently provide NACK in a voting type scheme.

Particular implementations of the subject matter described in this disclosure can be implemented to realize one or more of the following potential advantages. In some implementations, broadcast services can be deployed to support a new range of applications. Connectivity between a broadcaster (such as an AP) and a recipient (such as a STA) can be established using one or more of the described broadcast connectivity protocols. In some implementations, the described techniques can be used to optimize resource utilization by a wireless network that supports broadcast services. For example, an AP may optimize the data rate, modulation and coding scheme (MCS), redundancy configuration, FEC configuration, among other examples, based on feedback from STAs. As a result of optimizing the broadcast transmissions, the AP may reduce the quantity of retransmissions or may reduce the resource utilization associated with broadcast transmissions.

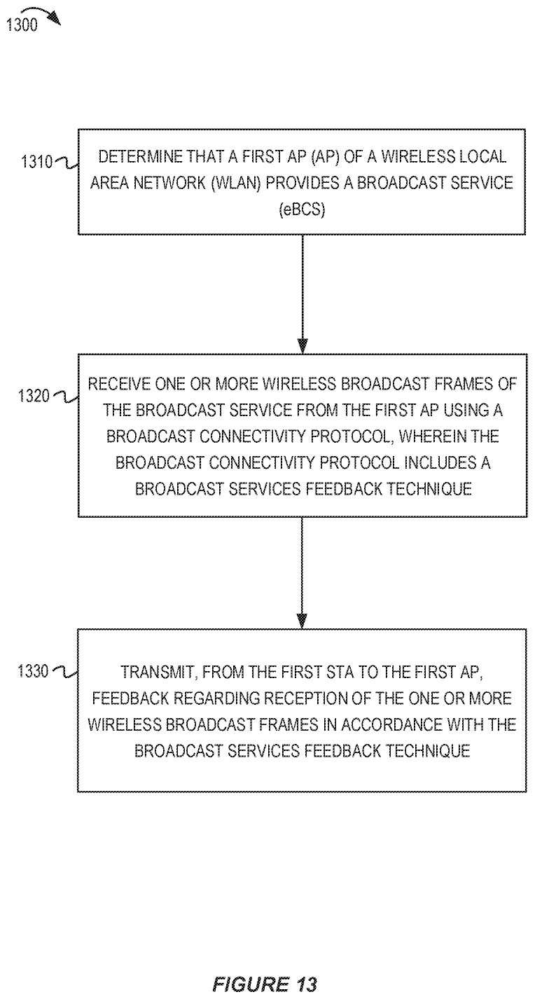

FIG. 13 shows a flowchart illustrating an example process 1300 for establishing connectivity for broadcast services. In some implementations, the process 1300 may be performed by a first wireless communication device such as the wireless communication device 1100 described in FIG. 11 or by a wireless communication device for use in one of the STAs 104, 144 or 1024 described herein. In some implementations, the process 1300 begins in block 1310 with determining that a first AP of a WLAN provides a broadcast service (eBCS). In block 1320, the process 1300 proceeds with receiving one or more wireless broadcast frames of the broadcast service from the first AP using a broadcast connectivity protocol, wherein the broadcast connectivity protocol includes a broadcast services feedback technique. In block 1330, the process 1300 proceeds with transmitting, from the first STA to the first AP, feedback regarding reception of the one or more wireless broadcast frames in accordance with the broadcast services feedback technique.

In some implementations, block 1330 may include determining that a broadcast services application is executing on the first wireless communication device and receiving the one or more wireless broadcast frames in response to a determination that the broadcast services application is executing.

In some implementations, block 1310 may include receiving an advertisement message that indicates the broadcast service. For example, the advertisement message may indicate that one or more broadcast services available from the second wireless communication device. The broadcast connectivity protocol may include a NAN protocol, an OCB protocol, among other examples.

In some implementations, the broadcast services application in block 1320 may include an emergency alert service, a vehicular application, among other examples.

In some implementations, block 1320 may include subscribing to a one-to-many NDL in a NAN cluster implemented in a WLAN. In some implementations, block 1330 may include operating an OCB mode of the first wireless communication device.

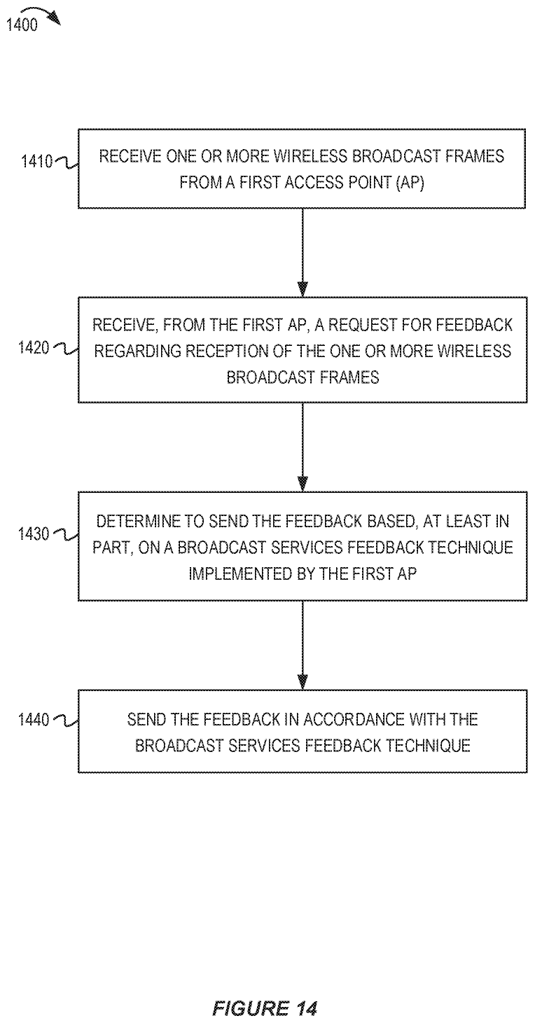

FIG. 14 shows a flowchart illustrating an example process 1400 for receiving broadcast services. In some implementations, the process 1400 may be performed by a wireless communication device such as the wireless communication device 1100 described in FIG. 11 or by a wireless communication device for use in one of the STAs 104, 144 and 1024 described herein. In some implementations, the process 1400 begins in block 1410 with receiving one or more wireless broadcast frames from a first AP. For example, the one or more wireless broadcast frames may be received via broadcast transmissions from the first AP. In block 1420, the process 1400 proceeds with receiving, from the first AP, a request for feedback regarding reception of the one or more wireless broadcast frames. In block 1430, the process 1400 proceeds with determining to send the feedback based, at least in part, on a broadcast services feedback technique implemented by the first AP. In block 1440, the process 1400 proceeds with sending the feedback in accordance with the broadcast services feedback technique.

In some implementations, the broadcast services feedback technique may be based on a NACK message scheme. For example, the request for feedback in block 1420 may solicit a response from the STA when the STA has not received a threshold quantity of wireless broadcast frames during a broadcast period.

In some implementations, sending the feedback in block 1440 may include determining a random time within a duration defined by a NAV that is available for multiple feedback messages from multiple STAs. The process 1400 may include sending the feedback at the random time to avoid collision with a transmission from another STA.

In some implementations, the broadcast services feedback technique may be based on a NACK polling scheme. For example, sending the feedback in block 1440 may include sending a NDP short message report concurrently with one or more other STAs.

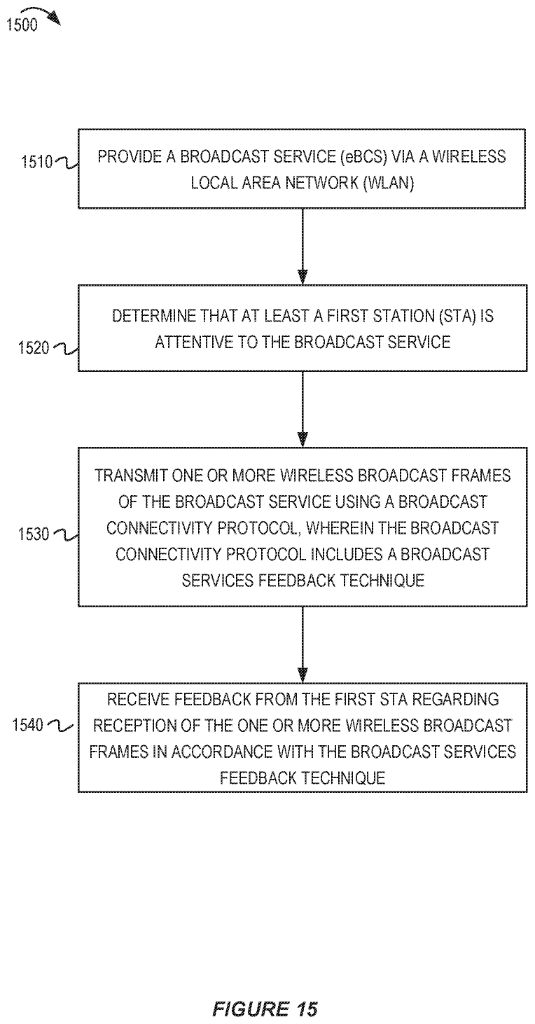

FIG. 15 shows a flowchart illustrating another example process 1500 for establishing connectivity for broadcast services. In some implementations, the process 1500 may be performed by a second wireless communication device such as the wireless communication device 1100 described in FIG. 11 or by a wireless communication device for use in one of the APs 102 and 1202 described herein. In some implementations, the process 1500 begins in block 1510 with providing a broadcast service (eBCS) via a wireless local area network (WLAN). In block 1520, the process 1500 proceeds with determining that at least a first station (STA) is attentive to the broadcast service. In block 1530, the process 1500 proceeds with transmitting one or more wireless broadcast frames of the broadcast service using a broadcast connectivity protocol, wherein the broadcast connectivity protocol includes a broadcast services feedback technique. In block 1540, the process 1500 proceeds with receiving feedback from the first STA regarding reception of the one or more wireless broadcast frames in accordance with the broadcast services feedback technique.

In some implementations, the broadcast connectivity protocol used in block 1530 may include a NAN protocol or an OCB.

In some implementations, block 1530 may include transmitting an advertisement message regarding the broadcast service provided by the second wireless communication device. Block 1530 may include transmitting a schedule or TWT data useable by the first wireless communication device to determine wake-up periods associated with the broadcast service.

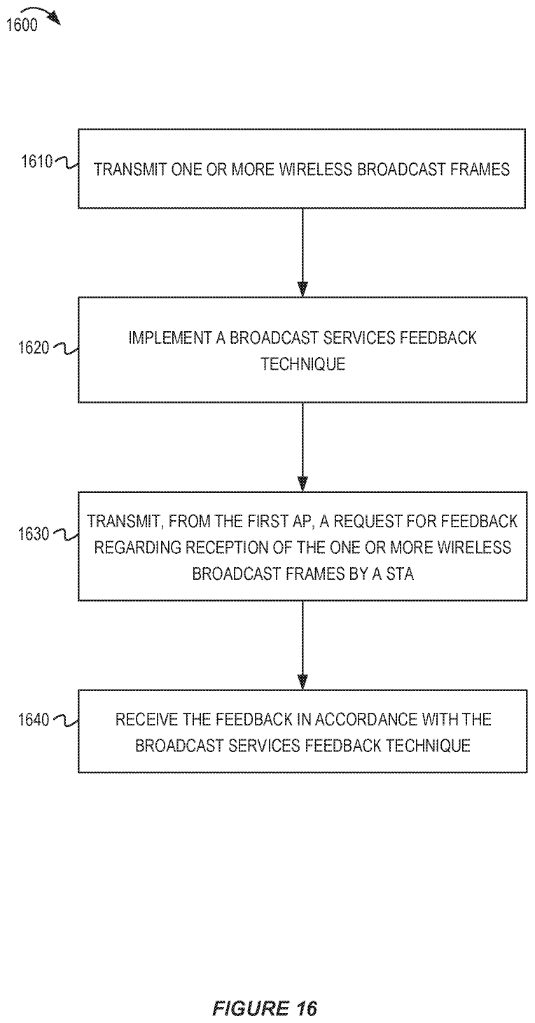

FIG. 16 shows a flowchart illustrating an example process 1600 for transmitting broadcast services. In some implementations, the process 1600 may be performed by a wireless communication device such as the wireless communication device 1100 described in FIG. 11 or by a wireless communication device for use in one of the APs 102 and 1202 described herein. In some implementations, the process 1600 begins in block 1610 with transmitting one or more wireless broadcast frames. In block 1620, the process 1600 proceeds with implementing a broadcast services feedback technique. In block 1630, the process 1600 proceeds with transmitting, from the first AP, a request for feedback regarding reception of the one or more wireless broadcast frames by a STA. In block 1640, the process 1600 proceeds with receiving the feedback in accordance with the broadcast services feedback technique.

In some implementations, the feedback in block 1640 may include a NACK message from the STA. In some implementations, the feedback in block 1640 may be used as a representative status for multiple STAs. In some implementations, the feedback in block 1640 may include an NDP short message report that includes concurrent feedback from multiple STAs.

In some implementations, the process 1600 may include changing a data rate or other communication parameter for subsequent wireless broadcast frames based on the feedback received in block 1640. For example, the process 1600 may include decreasing the data rate for the subsequent wireless broadcast frames if the feedback suggests an error rate above a threshold. Alternatively, the process 1600 may include increasing the data rate for the subsequent wireless broadcast frames if the feedback suggests an error rate below a threshold.

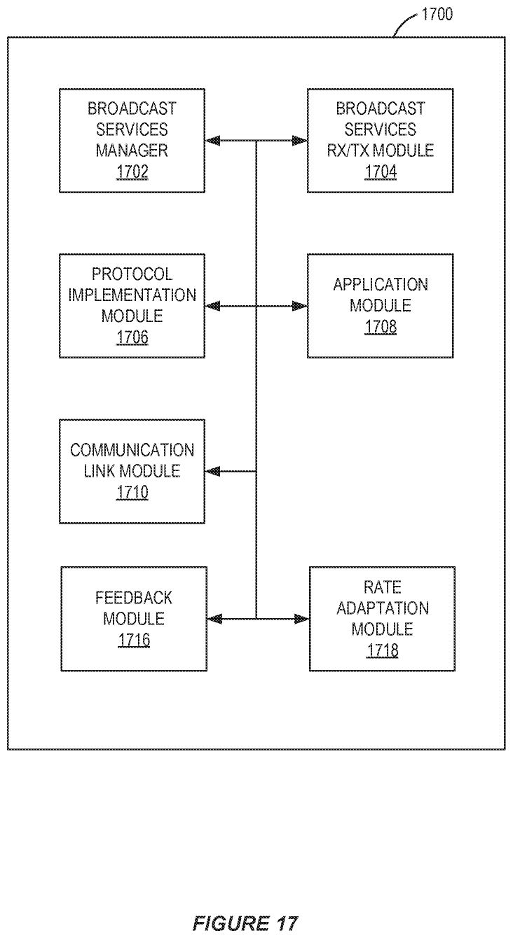

FIG. 17 shows a block diagram of an example wireless communication device 1700 for use in wireless communication. In some implementations, the wireless communication device 1700 can be an example of the STAs 104, 144 and 400 described above with reference to FIGS. 1, 2A, 2B, 4, 5A, 5B and 6, respectively. In some implementations, the wireless communication device 1700 can be an example of the APs 102 and 300 described above with reference to FIGS. 1, 2A, 2B, 3, 5A, 5B and 6, respectively. In some implementations, the wireless communication device 1700 is configured to perform one or more of the processes 1300, 1400, 1500 and 1600 described above with reference to FIGS. 13, 14, 15 and 16, respectively. The wireless communication device 1700 may include one or more of the following modules: a broadcast services manager 1702, a broadcast services receive or transmit module 1704, a protocol implementation module 1706, an application module 1708, a communication link module 1710, a feedback module 1716, and a rate adaption module 1718. Portions of one or more of the modules 1702, 1704, 1706, 1708, 1710, 1716 and 1718 may be implemented at least in part in hardware or firmware. For example, the broadcast services receive or transmit module 1704 may be implemented at least in part by one or more modems (for example, a Wi-Fi (IEEE 802.11) modem). In some implementations, at least some of the modules 1702, 1704, 1706, 1708, 1710, 1716 and 1718 are implemented at least in part as software stored in a memory (such as the memory 320 or the memory 420). For example, portions of one or more of the modules 1702, 1704, 1706, 1708, 1710, 1716 and 1718 can be implemented as non-transitory instructions (or “code”) executable by at least one processor (such as the processor 1106) to perform the functions or operations of the respective module.

The broadcast services manager 1702 may manage the broadcast service capabilities of an AP or a STA. For example, the broadcast services manager 1702 may manage which type of broadcast connectivity and feedback protocol(s) are implemented in a WLAN. The broadcast services manager 1702 may advertise capabilities indicators to inform other wireless communication devices which broadcast services are enabled in the wireless communication device 1700. The broadcast services receive or transmit module 1704 may implement the broadcast connectivity or feedback protocol. For example, the broadcast services receive or transmit module 1704 may be similar to the broadcast services receive unit 150 or the broadcast services transmit unit 120 described above. The protocol implementation module 1706 may implement the NAN protocol or the OCB protocol. For example, the protocol implementation module 1706 may modify the NAN protocol or the OCB protocol as needed by the broadcast services receive or transmit module 1704. The application module 1708 may implement the broadcast application that receives and processes the broadcast services. For example, the application module 1708 may include an EAS application, a vehicular use application, a video player, or any other type of application which may process broadcast transmissions. The communication link module 1710 may maintain a wireless association or an affiliation status between the wireless communication device 1700 and another wireless communication device. The feedback module 1716 may be configured to send or receive feedback in accordance with the broadcast services feedback technique. The rate adaption module 1718 may be configured to modify or adjust the data rate associated with broadcast transmissions based on feedback received from other wireless communication devices.

FIGS. 1-17 and the operations described herein are examples meant to aid in understanding example implementations and should not be used to limit the potential implementations or limit the scope of the claims. Some implementations may perform additional operations, fewer operations, operations in parallel or in a different order, and some operations differently.

One innovative aspect of the subject matter described in this disclosure can be implemented in a method for wireless communication. In some implementations, the method may be performed by a first wireless communication device. The method may include determining that a second wireless communication device provides a broadcast service, and receiving one or more wireless broadcast frames from the second wireless communication device using a broadcast connectivity protocol for the broadcast service.

Another innovative aspect of the subject matter described in this disclosure can be implemented in a wireless communication device. In some implementations, the wireless communication device may be a STA that includes at least one processor and at least one memory communicatively coupled with the at least one processor. The memory may store processor-readable code that, when executed by the at least one processor, may cause the wireless communication device to determine that a second wireless communication device provides a broadcast service, and receive one or more wireless broadcast frames from the second wireless communication device using a broadcast connectivity protocol for the broadcast service.

Another innovative aspect of the subject matter described in this disclosure can be implemented in a tangible computer-readable storage medium comprising non-transitory processor-executable code which, when executed by at least one processor of a first wireless communication device, may cause the first wireless communication device to receive one or more wireless broadcast frames from a second wireless communication device. The processor-executable code, when executed by the at least one processor, may cause the first wireless communication device to determine that a second wireless communication device provides a broadcast service, and receive one or more wireless broadcast frames from the second wireless communication device using a broadcast connectivity protocol for the broadcast service.

In some implementations, the methods, wireless communication devices and computer-readable storage media may be configured to determine that a broadcast services application is executing on the first wireless communication device, and receive the one or more wireless broadcast frames in response to a determination that the broadcast services application is executing.

In some implementations, the methods, wireless communication devices and computer-readable storage media may be configured to receive an advertisement message that indicates the broadcast service. The advertisement message may indicate one or more broadcast services available from the second wireless communication device.

In some implementations, the broadcast connectivity protocol may include a neighbor awareness networking (NAN) protocol. In some implementations, the methods, wireless communication devices and computer-readable storage media may be configured to determine that the second wireless communication device is operating a NAN data link (NDL) for the broadcast service.

In some implementations, the NDL may be a one-to-many NDL from the second wireless communication device to many wireless communication devices.

In some implementations, the methods, wireless communication devices and computer-readable storage media may be configured to receive one or more of the wireless broadcast frames via a third wireless communication device associated with the NDL. The first wireless communication device, the second wireless communication device and the third wireless communication device may be part of the same NAN.

In some implementations, the first wireless communication device and the third wireless communication device may have different NDL schedules. Each NDL schedule may be a combination of time frequency blocks.

In some implementations, the NDL may be used for more than one broadcast service provided by the second wireless communication device.

In some implementations, the methods, wireless communication devices and computer-readable storage media may be configured to determine synchronization for the broadcast service, wherein the synchronization is shared by multiple communication devices in the NDL.

In some implementations, the methods, wireless communication devices and computer-readable storage media may be configured to determine wake-up periods associated with the NDL, and receive the one or more wireless broadcast frames using the broadcast connectivity protocol for the broadcast service during the wake-up periods.

In some implementations, the wake-up periods associated with the NDL may include discovery windows (DWs) or NDL time blocks (NDL-TBs).

In some implementations, the methods, wireless communication devices and computer-readable storage media may be configured to determine other time periods different from the wake-up periods associated with the NDL, and enter a power save mode during at least some of the other time periods.

In some implementations, the methods, wireless communication devices and computer-readable storage media may be configured to determine other time periods different from the wake-up periods associated with the NDL, and access a Basis Service Set (BSS) of an infrastructure AP during at least some of the other time periods.

In some implementations, the broadcast connectivity protocol may include an outside context of a basic service set (OCB) protocol. In some implementations, the methods, wireless communication devices and computer-readable storage media may be configured to receive one or more OCB wireless broadcast frames.

In some implementations, the methods, wireless communication devices and computer-readable storage media may be configured to determine wake-up periods associated with the broadcast service based on a schedule for the one or more OCB wireless broadcast frames, and receive the one or more wireless broadcast frames using the broadcast connectivity protocol for the broadcast service during the wake-up periods.

In some implementations, the methods, wireless communication devices and computer-readable storage media may be configured to receiver a broadcast target wake time (TWT) schedule or a burst schedule from the second wireless communication device via the OCB protocol.

In some implementations, the broadcast connectivity protocol may include an independent basic service set (IBSS). In some implementations, the methods, wireless communication devices and computer-readable storage media may be configured to determine that the second wireless communication device is operating a NAN data link (NDL) for the broadcast service.

In some implementations, the broadcast service may be associated with an emergency alert service. In some implementations, the methods, wireless communication devices and computer-readable storage media may be configured to receive an emergency alert identifier element in a beacon or a probe response frame, receive an emergency alert universal resource identifier (URI) element in the beacon or the probe response frame, or receive an indicator that the first wireless communication device can access the broadcast service in a pre-association state.

In some implementations, the broadcast service may be associated with vehicular use data. In some implementations, the methods, wireless communication devices and computer-readable storage media may be configured to activate a vehicle connectivity protocol.

In some implementations, the methods, wireless communication devices and computer-readable storage media may be configured to determine that the second wireless communication device supports a pre-association process or a fast-association process for the broadcast service.

In some implementations, the methods, wireless communication devices and computer-readable storage media may be configured to maintain a communication link with an access point (AP), and periodically access the broadcast service provided by the second wireless communication device during some time periods while maintaining the communication link with the second AP during other time periods.

In some implementations, the communication link with the AP may be for non-broadcast traffic.

In some implementations, the first wireless communication device may be a station (STA) and the second wireless communication device is an access point (AP).

In some implementations, the STA may not have a wireless association with the AP.

In some implementations, the STA may have an affiliation status with the AP.

In some implementations, the methods, wireless communication devices and computer-readable storage media may be configured to obtain a public key associated with the second wireless communication device and decrypt at least a portion of the one or more wireless broadcast frames using the public key. In some implementations, the public key may be usable to verify that the one or more wireless broadcast frames originated from the second wireless communication device having a corresponding private key.

In some implementations, the methods, wireless communication devices and computer-readable storage media may be configured to receive the public key in a message from the second wireless communication device prior to receiving the one or more wireless broadcast frames.

In some implementations, the one or more wireless broadcast frames include a message authentication code (MAC). In some implementations, the methods, wireless communication devices and computer-readable storage media may be configured to verify the MAC using a key included in a subsequent wireless broadcast frame from the second wireless communication device.

Another innovative aspect of the subject matter described in this disclosure can be implemented in a method for wireless communication. In some implementations, the method may be performed by a first wireless station (STA). The method may include receiving one or more wireless broadcast frames from a first access point (AP). The method may include receiving, from the first AP, a request for feedback regarding reception of the one or more wireless broadcast frames. The method may include determining to send the feedback based, at least in part, on a broadcast services feedback technique implemented by the first AP. The method may include sending the feedback in accordance with the broadcast services feedback technique.

Another innovative aspect of the subject matter described in this disclosure can be implemented in a wireless communication device. In some implementations, the wireless communication device may be a first STA that includes at least one processor and at least one memory communicatively coupled with the at least one processor. The memory may store processor-readable code that, when executed by the at least one processor, may cause the first STA to receive one or more wireless broadcast frames from a first AP. The processor-readable code, when executed by the at least one processor, may cause the first STA to receive, from the first AP, a request for feedback regarding reception of the one or more wireless broadcast frames. The processor-readable code, when executed by the at least one processor, may cause the first STA to determine to send the feedback based, at least in part, on a broadcast services feedback technique implemented by the first AP. The processor-readable code, when executed by the at least one processor, may cause the first STA to send the feedback in accordance with the broadcast services feedback technique.

Another innovative aspect of the subject matter described in this disclosure can be implemented in a tangible computer-readable storage medium comprising non-transitory processor-executable code which, when executed by at least one processor of a first STA, may cause the first STA to receive one or more wireless broadcast frames from a first AP. The processor-executable code, when executed by the at least one processor, may cause the first STA to receive, from the first AP, a request for feedback regarding reception of the one or more wireless broadcast frames. The processor-executable code, when executed by the at least one processor, may cause the first STA to determine to send the feedback based, at least in part, on a broadcast services feedback technique implemented by the first AP. The processor-executable code, when executed by the at least one processor, may cause the first STA to send the feedback in accordance with the broadcast services feedback technique.

In some implementations, the broadcast services feedback technique may include a negative acknowledgement (NACK) message scheme and the feedback may include a NACK message.

In some implementations, the request includes a request that the first STA respond with the feedback if the first STA determines that it has not received a threshold quantity of wireless broadcast frames during a broadcast period.

In some implementations, the methods, wireless communication devices and computer-readable storage media may be configured to determine a random time within a network access vector (NAV) period available for multiple feedback messages from multiple STAs. The methods, wireless communication devices and computer-readable storage media may be configured to send the feedback at the random time to avoid collision with a transmission from a second STA of the multiple STAs.

In some implementations, the broadcast services feedback technique may include a NACK voting scheme and the feedback may include a short feedback transmission.

In some implementations, the methods, wireless communication devices and computer-readable storage media may be configured to determine one or more NACK time periods relative to a start time for the short feedback transmission. The one or more NACK time periods may correspond to missing broadcast segments not received by the first STA. In some implementations, the methods, wireless communication devices and computer-readable storage media may be configured to transmit radio frequency energy during the one or more NACK time periods.

In some implementations, the methods, wireless communication devices and computer-readable storage media may be configured transmit the short feedback transmission concurrently with a second STA such that the short feedback transmission includes at least one bit value that is reinforced by radio energy contributed by both the first STA and the second STA.

In some implementations, wherein the first STA does not have a wireless association with the first AP during at least one of the receipt of the one or more wireless broadcast frames, the receipt of the request for feedback, or the sending of the feedback.

In some implementations, the methods, wireless communication devices and computer-readable storage media may be configured to determine that a broadcast services application is executed on the first STA. In some implementations, the methods, wireless communication devices and computer-readable storage media may be configured to process the one or more wireless broadcast frames in response to a determination that the broadcast services application is being executed.

In some implementations, the methods, wireless communication devices and computer-readable storage media may be configured to send an indication to the first AP that the first STA will receive the one or more wireless broadcast frames in response to the determination that the broadcast services application is being executed.

In some implementations, the methods, wireless communication devices and computer-readable storage media may be configured to establish an affiliation status with the first AP without establishing a wireless association with the first AP.

In some implementations, the broadcast services feedback technique may include a block acknowledgement (BA) message scheme and the feedback may include a BA message. In some implementations, the methods, wireless communication devices and computer-readable storage media may be configured to establish a wireless association with the first AP, and determine whether the first STA is designated to send the BA message from among a plurality of STAs based on a designation status, priority, or other indicator from the first AP. In some implementations, a subset of the plurality of STAs may be designated to send BA messages.

In some implementations, the methods, wireless communication devices and computer-readable storage media may be configured to receive other wireless broadcast frames from a second AP and combine the other wireless broadcast frames with the one or more wireless broadcast frames to recover a broadcast transmission. The feedback may be based on a combination of the other wireless broadcast frames with the one or more wireless broadcast frames.

In some implementations, the methods, wireless communication devices and computer-readable storage media may be configured to maintain a wireless association with a second AP, and observe a first wireless channel associated with broadcast services from the first AP. Receiving the one or more wireless broadcast frames from the first AP may include periodically receiving the one or more wireless broadcast frames via the first wireless channel.

In some implementations, the first wireless channel may be different from a second wireless channel used for the wireless association with the second AP.

In some implementations, the request may include a first value indicating a threshold quantity of broadcast segments. In some implementations, the methods, wireless communication devices and computer-readable storage media may be configured to determine a quantity of received broadcast segments included in the one or more wireless broadcast frames and determine whether to send the feedback based, at least in part, on a comparison of the quantity of received broadcast segments and the first value.

Another innovative aspect of the subject matter described in this disclosure can be implemented as methods, wireless communication devices or computer-readable storage media used at a first AP. The methods, wireless communication devices and computer-readable storage media may be configured to transmit one or more wireless broadcast frames. The methods, wireless communication devices and computer-readable storage media may be configured to implement a broadcast services feedback technique, The methods, wireless communication devices and computer-readable storage media may be configured to transmit, from the first AP, a request for feedback regarding reception of the one or more wireless broadcast frames by a STA. The methods, wireless communication devices and computer-readable storage media may be configured to receive the feedback in accordance with the broadcast services feedback technique.

In some implementations, the methods, wireless communication devices and computer-readable storage media may be configured to determine a modulation coding scheme (MCS) for subsequent wireless broadcast frames based, at least in part, on the feedback.

In some implementations, the methods, wireless communication devices and computer-readable storage media may be configured to select a different MCS with a higher data rate for the subsequent wireless broadcast frames when the feedback indicates that a threshold percentage of STAs successfully received the one or more wireless broadcast frames.

In some implementations, the broadcast services feedback technique is one of a NACK message scheme available to associated and unassociated STAs, a NACK polling scheme available to associated and unassociated STAs, and a BA message scheme available to associated STAs.

In some implementations, the feedback is a short feedback transmission. In some implementations, the methods, wireless communication devices and computer-readable storage media may be configured to determine one or more NACK time periods relative to a start time for the short feedback transmission, wherein each of the one or more NACK time periods correspond to different broadcast segments. In some implementations, the methods, wireless communication devices and computer-readable storage media may be configured to detect an amount of radio frequency energy during each the one or more NACK time periods. In some implementations, the methods, wireless communication devices and computer-readable storage media may be configured to determine, based on which of the one or more NACK time periods have radio frequency energy above a threshold amount, which broadcast segments to retransmit.

In some implementations, the methods, wireless communication devices and computer-readable storage media may be configured to establish an affiliation status with one or more STAs without establishing a wireless association with the one or more STAs, wherein the broadcast services feedback technique is used by the one or more STAs having the affiliation status.

In some implementations, the methods, wireless communication devices and computer-readable storage media may be configured to designate a representative subset of the one or more STAs to transmit feedback messages, and control broadcast retransmissions based on the feedback from the representative subset of the one or more STAs.

In some implementations, the methods, wireless communication devices and computer-readable storage media may be configured to estimate a quantity of STAs receiving the one or more wireless broadcast frames based, at least in part, on the feedback.

In some implementations, the methods, wireless communication devices and computer-readable storage media may be configured to transmit the one or more wireless broadcast frames using forward error correction (FEC) encoding that provides redundancy of broadcast segments associated with a broadcast transmission. In some implementations, the methods, wireless communication devices and computer-readable storage media may be configured to include, in the request, a first value indicating a threshold quantity of broadcast segments representing a minimum number of broadcast segments that can be received to recover the broadcast transmission. In some implementations, the request may solicit NACK from one or more STAs that have received less than the minimum number.

Terms related to “transmitting,” “sending” or “receiving” may refer to communication via components of an electronic device or may refer to communication from a part of the electronic device to another part of the electronic device. For example, aspects of the disclosure may be implemented as part of a communication chip or other circuitry including a plurality of interconnected, electrically conductive elements coupled with antenna or other circuitry of an electronic device.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication by a wireless communication device of a first wireless station (STA) comprising:
determining that a first access point (AP) of a wireless local area network (WLAN) provides a broadcast service (eBCS);
receiving one or more wireless broadcast frames of the broadcast service from the first AP using a broadcast connectivity protocol, wherein the broadcast connectivity protocol includes a broadcast services feedback technique; and
transmitting, from the first STA to the first AP, feedback regarding reception of the one or more wireless broadcast frames in accordance with the broadcast services feedback technique.

2. The method of claim 1, wherein determining that the first AP provides the broadcast service includes receiving an advertisement message that indicates the broadcast service, wherein the advertisement message indicates one or more broadcast services available from the first AP.

3. The method of claim 1, wherein the broadcast connectivity protocol includes an outside context of a basic service set (OCB) protocol, and wherein determining that the first AP provides the broadcast service includes receiving one or more OCB wireless broadcast frames.

4. The method of claim 3, further comprising:
determining wake-up periods associated with the broadcast service based on a schedule for the one or more OCB wireless broadcast frames; and
receiving the one or more wireless broadcast frames using the broadcast connectivity protocol for the broadcast service during the wake-up periods.

5. The method of claim 4, wherein determining the wake-up periods includes receiving a broadcast target wake time (TWT) schedule or a burst schedule from the first AP via the OCB protocol.

6. The method of claim 1, further comprising determining that the first AP supports a pre-association process or a fast-association process for the broadcast service.

7. The method of claim 1, further comprising:
maintaining a communication link with a second AP for non-broadcast traffic;
periodically accessing the broadcast service provided by the first AP during some time periods; and
communicating with the second AP during other time periods between periodically accessing the broadcast service.

8. The method of claim 1, wherein the broadcast connectivity protocol for the broadcast service does not include establishing a wireless association with the first AP.

9. The method of claim 1, further comprising:
obtaining a public key associated with the first AP prior to receiving the one or more wireless broadcast frames; and
decrypting at least a portion of the one or more wireless broadcast frames using the public key, wherein the public key is usable to verify that the one or more wireless broadcast frames originated from the first AP having a corresponding private key.

10. The method of claim 1, wherein the one or more wireless broadcast frames include a message authentication code (MAC), the method further comprising verifying the MAC using a key included in a subsequent wireless broadcast frame from the first AP.

11. The method of claim 1, further comprising:
receiving, from the first AP, a request for the feedback regarding reception of the one or more wireless broadcast frames; and
determining whether to transmit the feedback based, at least in part, on the broadcast services feedback technique implemented by the first AP.

12. The method of claim 11, wherein the broadcast services feedback technique includes a negative acknowledgement (NACK) message scheme and the feedback includes a NACK message.

13. The method of claim 11, wherein the request includes a request that the first STA respond with feedback if the first STA determines that it has not received a threshold quantity of wireless broadcast frames during a broadcast period.

14. The method of claim 11, wherein the broadcast services feedback technique includes a negative acknowledgement (NACK) voting scheme and the feedback includes a short feedback transmission.

15. The method of claim 14, further comprising:
determining one or more NACK time periods relative to a start time for the short feedback transmission, the one or more NACK time periods corresponding to missing broadcast segments not received by the first STA; and
transmitting radio frequency energy during the one or more NACK time periods.

16. The method of claim 14, wherein sending the feedback includes transmitting the short feedback transmission concurrently with a transmission from a second STA such that the short feedback transmission includes at least one bit value that is reinforced by radio energy contributed by both the first STA and the second STA.

17. The method of claim 1, further comprising establishing an affiliation status with the first AP without establishing a wireless association with the first AP.

18. The method of claim 1, further comprising:
receiving other wireless broadcast frames from a second AP; and
combining data from the other wireless broadcast frames with data from the one or more wireless broadcast frames to recover a broadcast transmission.

19. A wireless communication device for use in a first station (STA) comprising:
at least one processor; and
at least one memory communicatively coupled with the at least one processor and storing processor-readable code that, when executed by the at least one processor, causes the wireless communication device to perform operations comprising:
determining that a first access point (AP) of a wireless local area network (WLAN) provides a broadcast service (eBCS), and
receiving one or more wireless broadcast frames of the broadcast service from the first AP using a broadcast connectivity protocol, wherein the broadcast connectivity protocol includes a broadcast services feedback technique, and
transmitting, from the first STA to the first AP, feedback regarding reception of the one or more wireless broadcast frames in accordance with the broadcast services feedback technique.

20. The wireless communication device of claim 19, wherein the broadcast connectivity protocol includes an outside context of a basic service set (OCB) protocol, and wherein determining that the first AP provides the broadcast service includes receiving one or more OCB wireless broadcast frames.

21. The wireless communication device of claim 20, wherein the processor-readable code, when executed by the at least one processor, causes the wireless communication device to perform operations comprising:
determining wake-up periods associated with the broadcast service based on a schedule for the one or more OCB wireless broadcast frames; and
receiving the one or more wireless broadcast frames using the broadcast connectivity protocol for the broadcast service during the wake-up periods.

22. The wireless communication device of claim 20, wherein determining the wake-up periods includes receiving a broadcast target wake time (TWT) schedule or a burst schedule from the first AP via the OCB protocol.

23. The wireless communication device of claim 19, wherein the processor-readable code, when executed by the at least one processor, causes the wireless communication device to perform operations comprising:
maintaining a communication link with a second AP for non-broadcast traffic;
periodically accessing the broadcast service provided by the first AP during some time periods; and
communicating with the second AP during other time periods between periodically accessing the broadcast service.

24. The wireless communication device of claim 19, wherein the broadcast connectivity protocol for the broadcast service does not include establishing a wireless association with the first AP.

25. The wireless communication device of claim 19, wherein the processor-readable code, when executed by the at least one processor, causes the wireless communication device to perform operations comprising:
obtaining a public key associated with the first AP prior to receiving the one or more wireless broadcast frames; and
decrypting at least a portion of the one or more wireless broadcast frames using the public key, wherein the public key is usable to verify that the one or more wireless broadcast frames originated from the first AP having a corresponding private key.

26. The wireless communication device of claim 19, wherein the one or more wireless broadcast frames include a message authentication code (MAC), the wireless communication device further comprising verifying the MAC using a key included in a subsequent wireless broadcast frame from the first AP.

27. The wireless communication device of claim 19, wherein the broadcast services feedback technique includes a negative acknowledgement (NACK) message scheme and the feedback includes a NACK message.

28. The wireless communication device of claim 19, wherein the processor-readable code, when executed by the at least one processor, causes the wireless communication device to perform operations comprising receiving, from the first AP, a request for the feedback regarding reception of the one or more wireless broadcast frames to cause the first STA to respond with feedback if the first STA determines that it has not received a threshold quantity of wireless broadcast frames during a broadcast period.

29. The wireless communication device of claim 19, wherein the broadcast services feedback technique includes a negative acknowledgement (NACK) voting scheme and the feedback includes a short feedback transmission.

30. A mobile station comprising:
a wireless communication device comprising:
at least one processor, and
at least one memory communicatively coupled with the at least one processor and storing processor-readable code that, when executed by the at least one processor, causes the wireless communication device to perform operations comprising:
determining that a first access point (AP) of a wireless local area network (WLAN) provides a broadcast service (eBCS), and
receiving one or more wireless broadcast frames of the broadcast service from the first AP using a broadcast connectivity protocol, wherein the broadcast connectivity protocol includes a broadcast services feedback technique, and
transmitting, from the first STA to the first AP, feedback regarding reception of the one or more wireless broadcast frames in accordance with the broadcast services feedback technique;
at least one transceiver coupled to the wireless communication device;
at least one antenna coupled to the at least one transceiver to wirelessly transmit signals output from the at least one transceiver and to wirelessly receive signals for input into the at least one transceiver; and
a housing that encompasses the wireless communication device, the at least one transceiver and at least a portion of the at least one antenna.

31-52. (canceled)
